(19) United States
(12) Patent Application Publication
(10) Pub. No.: US 2014/0036501 A1
(43) Pub. Date: Feb. 6, 2014

(54) VIRTUAL IMAGE DISPLAYING DECORATIVE BODY AND METHOD OF MANUFACTURING VIRTUAL IMAGE DISPLAYING DECORATIVE BODY

(71) Applicant: SEIKO EPSON CORPORATION, Tokyo (JP)

(72) Inventors: Yasushi Takano, Matsumoto-shi (JP); Toshimitsu Hirai, Hokuto-shi (JP)

(73) Assignee: SEIKO EPSON CORPORATION, Tokyo (JP)

(21) Appl. No.: 13/955,949

(22) Filed: Jul. 31, 2013

(30) Foreign Application Priority Data
Aug. 1, 2012 (JP) 2012-170876

(51) Int. Cl. F21V 5/04

(52) U.S. Cl. CPC F21V 5/04
USPC 362/244; 427/162

(57) ABSTRACT

A virtual image displaying decorative body includes a unit array including pixel units arranged, and a light condensing element array including a plurality of light condensing elements, in which the light condensing elements are arranged at positions associated with the pixel units, and the light condensing element array includes the light condensing elements of which plan view shapes are ellipses.

### BACKGROUND

1. Technical Field

The present invention relates to a virtual image displaying decorative body which includes pixel units arranged in a regular manner and light condensing elements arranged in a regular manner at positions in which they cover the pixel units and in which the pixel units make an enlarged virtual image to appear, and a method of manufacturing the virtual image displaying decorative body.

2. Related Art

In the related art, a virtual image displaying decorative body has been known which includes a unit array including pixel units arranged in a regular manner and a light condensing element array including lens-shaped light condensing elements arranged in a regular manner at positions in which they cover the pixel units and in which the pixel units make an enlarged virtual image to appear.

JP-A-2005-7593 discloses a virtual image displaying decorative body which includes a plano-convex lens-shaped light condensing layer (light condensing element array) configured by lens-shaped light condensing elements arranged in a lattice shape, and an image (unit array) configured by pixels (pixel units) of which each is formed into 20 to 80% of the size of a square in the lattice of the light condensing element, thereby causing any character strings to appear as virtual images upwardly or downwardly.

However, the virtual image that can be made to appear is an enlarged image of pixels (pixel units), and a shape, a color, or the like thereof is uniformly determined by pixels (pixel unit). For this reason, there is a problem that pixels (pixel unit) specific to each virtual image made to appear are necessary, in order to make different virtual images to appear.

### SUMMARY

The invention can be realized in the following forms or application examples.

### Application Example 1

According to this application example, there is provided a virtual image displaying decorative body including a unit array including pixel units arranged; and a light condensing element array including a plurality of light condensing elements, the light condensing elements being arranged at positions associated with the pixel units, in which the light condensing element array includes the light condensing elements of which plan view shapes are ellipses.

In the virtual image displaying decorative body according to the application example, the light condensing element array constituting the virtual image displaying decorative body includes light condensing elements of which plan view shapes are ellipses. The virtual image displaying decorative body makes an enlarged virtual image of the pixel units to appear by the light condensing elements arranged at positions associated with the pixel units. Each of the light condensing elements included in the light condensing element array makes an enlarged virtual image of pixel units constituting the unit array to appear. However, the magnification of the virtual image is significantly large, so that a virtual image which can be visually recognized by one light condensing element is a part of the enlarged virtual image of pixel units. In the whole light condensing element array, a part of the enlarged virtual image made to appear by each of the light condensing elements included in the light condensing element array is visually recognized as one enlarged virtual image as a whole.

In the light condensing element of which a plan view shape is an ellipse, the radii of curvatures on the curved sides are different and the focal lengths are not uniform at respective cross sections of which the plan view directions are different. In other words, the magnification varies depending on a direction. For example, the virtual image by the light condensing element of which the plan view shape is an ellipse has a shape in which the pixel unit is stretched in one direction. Accordingly, the virtual image has a shape in which the shape of the pixel unit is deformed. Since the plan view shape of the light condensing element is an ellipse, it is possible to make a virtual image to appear, which has a shape in which the shape of the pixel unit is deformed. Since the plan view shapes of the light condensing elements are different, it is possible to make virtual images to appear in different shapes, using the pixel units having the same shape.

### Application Example 2

It is preferable that the virtual image displaying decorative body according to the application example further include first light condensing elements of which each longitudinal direction of the ellipse is a first direction; and second light condensing elements of which each longitudinal direction of the ellipse is a second direction different from the first direction.

The virtual image displaying decorative body includes the first light condensing element and the second light condensing element of which longitudinal directions of the ellipses are different from each other. The virtual image made to appear by the virtual image displaying decorative body in which the light condensing elements included are all first light condensing elements is referred to as a first virtual image, whereas the virtual image made to appear by the virtual image displaying decorative body in which the light condensing elements included are all second light condensing elements is referred to as a second virtual image.

In the virtual image displaying decorative body according to the application example, a portion to be visually recognized through the first light condensing element has a shape of the first virtual image, whereas a portion to be visually recognized through the second light condensing element has a shape of the second virtual image. The virtual image to be visually recognized in the virtual image displaying decorative body is a virtual image of which a part has a shape of the first virtual image, and the other part thereof has a shape of the second virtual image. It is possible to make virtual images to appear in various shapes in which virtual images of different shapes are combined, by a combination of the orientations of the light condensing elements, using pixel units having the same shape.

### Application Example 3

It is preferable that the virtual image displaying decorative body according to the application example further include third light condensing elements of which each plan view shape is a first ellipse; and fourth light condensing elements of which each plan view shape is different from the first ellipse.

The virtual image displaying decorative body includes the third light condensing element and the fourth light condensing element of which the shapes are different from each other. The virtual image made to appear by the virtual image displaying decorative body in which the light condensing elements included are all third light condensing elements is referred to as a third virtual image, whereas the virtual image made to appear by the virtual image displaying decorative body in which the light condensing elements included are all fourth light condensing elements is referred to as a fourth virtual image. Since the third light condensing element and the fourth light condensing element have different plan view shapes, the third virtual image and the fourth virtual image have different shapes.

In the virtual image displaying decorative body according to the application example, a portion to be visually recognized through the third light condensing element has a shape of the third virtual image, whereas a portion to be visually recognized through the fourth light condensing element has a shape of the fourth virtual image. The virtual image to be visually recognized in the virtual image displaying decorative body is a virtual image of which a part thereof is a shape of the third virtual image, and the other part thereof is a shape of the fourth virtual image. It is possible to make virtual images to appear in various shapes in which virtual images of different shapes are combined, by a combination of the orientations of the light condensing elements, using pixel units having the same shape.

### Application Example 4

It is preferable that the virtual image displaying decorative body according to the application example further include a first light condensing element array including the first light condensing elements and the second light condensing elements.

In the virtual image displaying decorative body, one first light condensing element array includes the first light condensing element and the second light condensing element. In the first light condensing element array, a portion to be visually recognized through the first light condensing element has a shape of the first virtual image, whereas a portion to be visually recognized through the second light condensing element has a shape of the second virtual image. The virtual image to be visually recognized through the first light condensing element array is a virtual image of which a part thereof has a shape of the first virtual image, and the other part thereof has a shape of the second virtual image. In a range of one light condensing element array, it is possible to make virtual images to appear in various shapes in which virtual images of different shapes are combined, by a combination of the light condensing elements, using pixel units having the same shape.

### Application Example 5

It is preferable that the virtual image displaying decorative body according to the application example further include a second light condensing element array including the third light condensing elements and the fourth light condensing elements.

In the virtual image displaying decorative body, one second light condensing element array includes the third light condensing element and the fourth light condensing element. In the second light condensing element array, a portion to be visually recognized through the third light condensing element has a shape of the third virtual image, whereas a portion to be visually recognized through the fourth light condensing element has a shape of the fourth virtual image. The virtual image to be visually recognized through the second light condensing element array is a virtual image of which a part thereof has a shape of the third virtual image, and the other part thereof has a shape of the fourth virtual image. In a range of one light condensing element array, it is possible to make virtual images to appear in various shapes in which virtual images of different shapes are combined, by a combination of the light condensing elements having different shapes, using pixel units having the same shape.

### Application Example 6

It is preferable that the virtual image displaying decorative body according to the application example further include a third light condensing element array including the first light condensing elements; and a fourth light condensing element array including the second light condensing elements.

In the virtual image displaying decorative body, the virtual image displaying decorative body includes the third light condensing element array and the fourth light condensing element array. The first virtual image by the first light condensing element is made to appear in the part of the third light condensing element array of the virtual image displaying decorative body. The second virtual image by the second light condensing element is made to appear in the part of the fourth light condensing element array of the virtual image displaying decorative body. The virtual image made to appear in the part of the third light condensing element array and the virtual image made to appear in the part of the fourth light condensing element array have different shapes. In other words, it is possible to make virtual images to appear in different shapes for each light condensing element array, using pixel units having the same shape.

### Application Example 7

It is preferable that the virtual image displaying decorative body according to the application example further include a fifth light condensing element array including the third light condensing elements; and a sixth light condensing element array including the fourth light condensing elements.

In the virtual image displaying decorative body, the virtual image displaying decorative body includes the fifth light condensing element array and the sixth light condensing element array. The third virtual image by the third light condensing element is made to appear in the part of the fifth light condensing element array of the virtual image displaying decorative body. The fourth virtual image by the fourth light condensing element is made to appear in the part of the sixth light condensing element array of the virtual image displaying decorative body. The virtual image made to appear in the part of the fifth light condensing element array and the virtual image made to appear in the part of the sixth light condensing element array have different shapes. In other words, it is possible to make virtual images to appear in different shapes for each light condensing element array, by using pixel units having the same shape.

### Application Example 8

According to this application example, there is provided a method of manufacturing a virtual image displaying decorative body which includes a unit array including pixel units arranged, and a light condensing element array including a plurality of light condensing elements, the light condensing elements being arranged at positions associated with the pixel units, in which the light condensing element array includes the light condensing elements of which plan view shapes are ellipses, and in which both or one of the pixel unit and the light condensing element are formed using a droplet ejecting apparatus that ejects droplets.

In the method of manufacturing the virtual image displaying decorative body according to the application example, the virtual image displaying decorative body is manufactured in which plan view shapes of light condensing elements constituting the virtual image displaying decorative body are ellipses. The virtual image displaying decorative body makes an enlarged virtual image of pixel units to appear by the light condensing elements arranged at positions associated with the pixel units. Each of the light condensing elements included in the light condensing element array makes an enlarged virtual image of pixel units constituting the unit array to appear. However, since the magnification of the virtual image is significantly large, a virtual image which can be visually recognized by one light condensing element is a part of the enlarged virtual image of pixel units. In the whole light condensing element array, a part of the enlarged virtual image made to appear by each of the light condensing elements included in the light condensing element array is visually recognized as one enlarged virtual image as a whole.

In the light condensing element of which plan view shape is an ellipse, the radii of curvatures on the curved sides are different and the focal lengths are not uniform at respective cross sections of which the plan view directions are different. In other words, the magnification varies depending on a direction. For example, the virtual image by the light condensing element of which the plan view shape is an ellipse has a shape in which the pixel unit is stretched in one direction. Accordingly, the virtual image has a shape in which the shape of the pixel unit is deformed. Since the plan view shape of the light condensing element is an ellipse, it is possible to manufacture a virtual image displaying decorative body that makes a virtual image to appear, which has a shape in which the shape of the pixel unit is deformed. Since the plan view shapes of the light condensing elements are different, it is possible to manufacture a virtual image displaying decorative body that can make virtual images to appear in different shapes by using the pixel units having the same shape.

Further, in the method of manufacturing a virtual image displaying decorative body according to the application example, both or one of the pixel units and the light condensing elements are formed by using a droplet ejecting apparatus. In other words, the pixel units are drawn at positions arranged at predetermined relationships, by using the droplet ejecting apparatus. The droplet ejecting apparatus is used, so that it is possible to arrange droplets in correct volumes at correct positions. Accordingly, it is possible to form the pixel units having correct shapes, arranged in a correct positional relationship. Further, the light condensing elements are drawn at positions to be arranged in a predetermined positional relationship by using the droplet ejecting apparatus. Thus, it is possible to form the light condensing elements having correct shapes, arranged in a correct positional relationship. Further, the shape to be drawn can be easily changed by using the droplet ejecting apparatus, so that it is possible to easily form a virtual image displaying decorative body having light condensing elements of different shapes.

### BRIEF DESCRIPTION OF THE DRAWINGS

The invention will be described with reference to the accompanying drawings, wherein like numbers reference like elements.

FIG. 1A is an external perspective view illustrating a schematic configuration of an entire droplet ejecting apparatus, and FIG. 1B is an external perspective view illustrating a schematic configuration of a droplet ejecting head that the droplet ejecting apparatus includes.

FIG. 2A is an explanatory diagram illustrating arrangement positions of the ejecting nozzles, FIG. 2B is an explanatory diagram illustrating a state where droplets are landed in a line shape in an extension direction of a nozzle row, FIG. 2C is an explanatory diagram illustrating a state where droplets are landed in a line shape in an ejection scanning direction, and FIG. 2D is an explanatory diagram illustrating a state where droplets are landed in a planar shape.

FIG. 3A is a cross-sectional diagram illustrating a main part of a virtual image displaying decorative body, and FIG. 3B is a schematic plan view illustrating virtual images made to appear on the virtual image displaying decorative body.

FIG. 4A is a plan view illustrating a pixel array of the virtual image displaying decorative body, FIG. 4B is an enlarged plan view of the pixel array, FIG. 4C is a plan view illustrating virtual image regions of the virtual image displaying decorative body, FIG. 4D is an enlarged plan view of the lens array arranged in one of the virtual image regions illustrated in FIG. 4C, FIG. 4E is a plan view illustrating configurations of the virtual image regions and the pixel array of the virtual image displaying decorative body, and FIG. 4F is an enlarged plan view of the lens array and the pixel array that are arranged in one of the virtual image regions illustrated in FIG. 4E.

FIG. 5A is a plan view illustrating the virtual image region of the virtual image displaying decorative body, FIG. 5B is an enlarged plan view of the lens array arranged in the virtual image region illustrated in FIG. 5A, FIG. 5C is a plan view illustrating configurations of the virtual image region and the pixel array of the virtual image displaying decorative body, FIG. 5D is an enlarged plan view of the lens array and the pixel array that are arranged in the virtual image region illustrated in FIG. 5C, FIG. 5E is an enlarged plan view of the lens array and the pixel array that are arranged in the virtual image region, and FIG. 5F is an enlarged plan view of the lens array and the pixel array that are arranged in the virtual image region.

FIG. 6A is a plan view illustrating an arrangement of micro-lenses in the lens array, FIG. 6B is a plan view illustrating a shape of the micro-lens, and FIG. 6C is an explanatory diagram illustrating a shape of a virtual image made to appear by the micro-lens illustrated in FIG. 6B, FIG. 6D is a plan view illustrating the shape of the micro-lens, and FIG. 6E is an explanatory diagram illustrating a shape of a virtual image made to appear by the micro-lens illustrated in FIG. 6D.

FIGS. 7A, 7B, 7C and 7D are explanatory diagrams illustrating shapes of virtual images made to appear by a sub-lens array, and FIG. 7E is an explanatory diagram illustrating a shape of the virtual image made to appear by the micro-lens array.

FIG. 8A is a plan view illustrating an arrangement of the micro-lenses in the lens array, FIGS. 8B and 8C are explanatory diagrams illustrating shapes of virtual images made to appear by a part of the micro-lenses illustrated in FIG. 8A, and FIG. 8D is an explanatory diagram illustrating a shape of a virtual image made to appear by the micro-lenses illustrated in FIG. 8A.

FIG. 9A is a plan view illustrating an arrangement of the micro-lenses in the lens array, FIGS. 9B, 9C and 9D are explanatory diagrams illustrating shapes of virtual images made to appear by a part of the micro-lenses illustrated in FIG. 9A, and FIG. 9E is an explanatory diagram illustrating a shape of a virtual image made to appear by the micro-lenses illustrated in FIG. 9A.

FIG. 10A is an explanatory diagram illustrating a configuration of a lens array of the virtual image displaying decorative body, and FIG. 10B is a plan view illustrating a shape of a virtual image made to appear.

FIG. 11A is an explanatory diagram illustrating a configuration of a lens array of the virtual image displaying decorative body, and FIG. 11B is a plan view illustrating a shape of a virtual image made to appear.

FIG. 12A is an explanatory diagram illustrating a configuration of a lens array of the virtual image displaying decorative body, and FIG. 12B is a plan view illustrating a shape of a virtual image made to appear.

### DESCRIPTION OF EXEMPLARY EMBODIMENTS

Hereinafter, embodiments of a virtual image displaying decorative body and a method of manufacturing a virtual image displaying decorative body according to the present invention will be described with reference to drawings. Further, in the drawings referred in the following description, for convenience of illustration, horizontal and vertical scales of members or portions may be represented different from actual sizes.

### Droplet Ejecting Apparatus

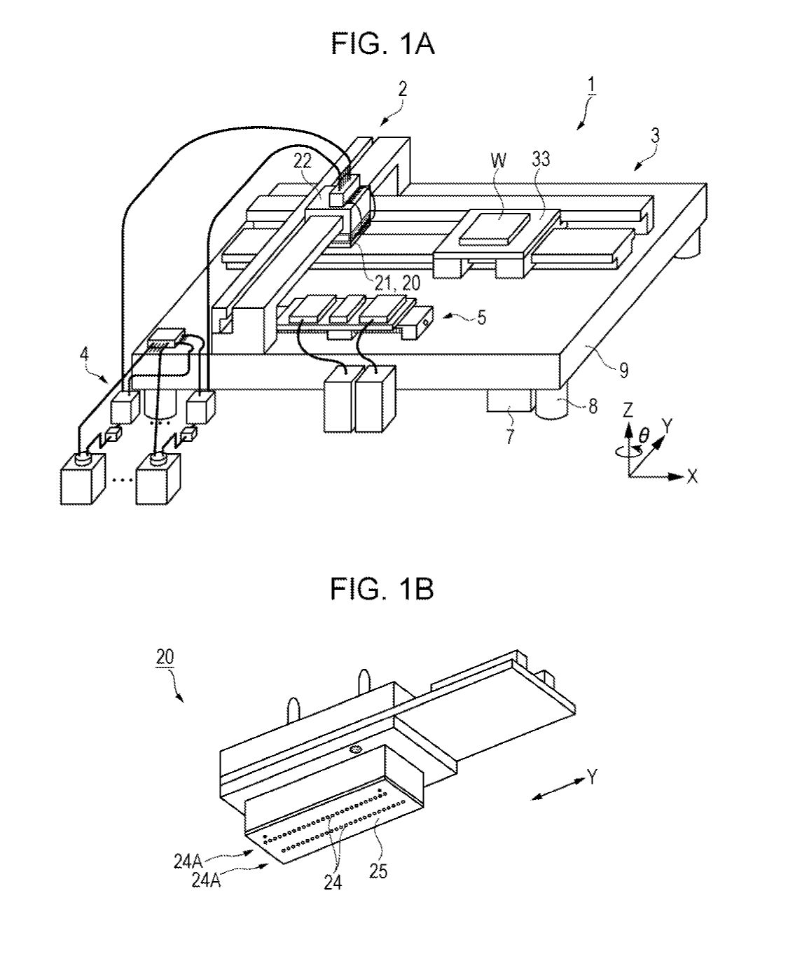

First, a droplet ejecting apparatus 1 will be described with reference to FIGS. 1A and 1B. FIGS. 1A and 1B are external perspective views illustrating a schematic configuration of a droplet ejecting apparatus. FIG. 1A is an external perspective view illustrating a schematic configuration of an entire droplet ejecting apparatus, and FIG. 1B is an external perspective view illustrating a schematic configuration of a droplet ejecting head that the droplet ejecting apparatus includes.

As illustrated in FIGS. 1A and 1B, the droplet ejecting apparatus 1 includes a head mechanism unit 2, a work mechanism unit 3, a functional fluid supplying unit 4, a maintenance device unit 5, and an ejecting device control unit 7. The head mechanism unit 2 includes a droplet ejecting head 20 that ejects a functional fluid as a droplet. The head mechanism unit 2 has an ultraviolet irradiation unit, not shown. The work mechanism unit 3 includes a work mounting table 33 on which a work W is mounted. Here, the work W is an ejecting object (drawing object) of droplets ejected from the droplet ejecting head 20. The functional fluid supplying unit 4 supplies the droplet ejecting head 20 with the functional fluid. The maintenance device unit 5 performs maintenance of the droplet ejecting head 20. The ejecting device control unit 7 performs an overall control of each mechanism unit. Further, the droplet ejecting apparatus 1 includes a plurality of supporting legs 8, and a platen 9 placed on an upper side of the supporting legs 8.

The work mechanism unit 3 is disposed on the upper surface of the platen 9. The work mechanism unit 3 extends in a longitudinal direction (an X axis direction) of the platen 9. The head mechanism unit 2, which is supported by two supporting pillars fixed to the platen 9, is disposed above the work mechanism unit 3. The head mechanism unit 2 extends in a direction substantially orthogonal to the work mechanism unit 3 (a Y axis direction). A functional fluid tank of the functional fluid supplying unit 4 having supply pipes communicating with the droplet ejecting head 20 of the head mechanism unit 2 is disposed in the vicinity of the platen 9. In the vicinity of the support pillar in one side of the head mechanism unit 2, the maintenance device unit 5 extends in the X direction along with the work mechanism unit 3 and is arranged. Further, the ejecting device control unit 7 is accommodated on the lower side of the platen 9.

The head mechanism unit 2 includes a head unit 21 having the droplet ejecting head 20 and a head carriage 22 that supports the head unit 21. The droplet ejecting head 20 is freely moved in the Y axis direction by moving the head carriage 22 in the Y axis direction. Further, the droplet ejecting head 20 is held in the moved position. The work mechanism unit 3 freely moves the work W mounted on the work mounting table 33 in the X axis direction by moving the work mounting table 33 in the X axis direction. Further, the work W is held in the moved position.

The droplet ejecting head 20 is moved to and stopped at an ejecting position in the Y axis direction and the functional fluid is ejected as droplets in synchronization with the movement of work W which is at the bottom in the X-axis direction. The X direction which is a relative movement direction (scan direction) between the droplet ejecting head 20 and the work W, and accompanied by ejecting the functional fluid from the droplet ejecting head 20 is referred to as an ejection scanning direction.

Droplets are landed in a certain position on the work W by relatively controlling the work W which is moved in the X axis direction and the droplet ejecting head 20 which is moved in the Y axis direction, and thus it is possible to perform a desired drawing.

As illustrated in FIG. 1B, the droplet ejecting head 20 has a nozzle substrate 25. The nozzle substrate 25 has two nozzle rows 24A in which a plurality of ejecting nozzles 24 are arranged in a substantially line shape. The functional fluid is ejected as droplets from the ejecting nozzles 24, and landed on the work W located at a position opposed thereto, whereby the functional fluid is disposed at a position corresponding thereto. The nozzle rows 24A extend in the Y axis direction illustrated in FIG. 1A, in a state where the droplet ejecting head 20 is mounted on the droplet ejecting apparatus 1. The ejecting nozzles 24 are arranged at an equally spaced nozzle pitch in the nozzle row 24A. The positions of the ejecting nozzles 24 are shifted by half of a nozzle pitch in the Y axis direction between two nozzle rows 24A. Accordingly, the droplet ejecting head 20 can dispose droplets of the functional fluid at the interval of half the nozzle pitch in the Y axis direction.

In order to expand a drawing range in the Y axis direction, the droplet ejecting head 20 may be arranged in the Y axis direction. Otherwise, the movement of the work W in the X axis direction and the ejection from the droplet ejecting head 20 may be performed at each position of the droplet ejecting head 20 in the Y axis direction by moving the droplet ejecting head 20 in the Y axis direction.

In order to reduce an arrangement pitch of the droplets in the Y axis direction, a plurality of droplet ejecting heads 20 may be arranged in the X axis direction by shifting the positions of the ejecting nozzles 24 in the Y axis direction with each other, or a droplet ejecting head including nozzle rows of three rows or more may be used. Of course, a droplet ejecting head having a small nozzle pitch may be used, if the droplet ejecting head can be manufactured.

### Landing Position

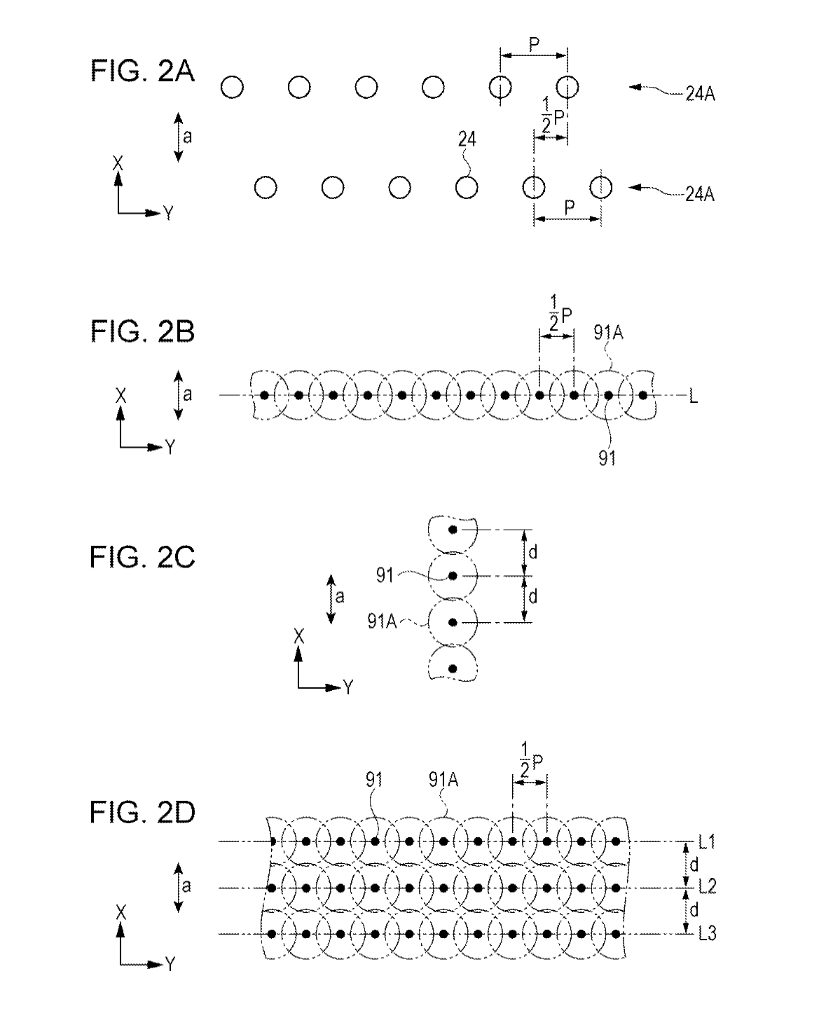

Next, relationship between the ejecting nozzles 24 of the droplet ejecting head 20 and the landing positions of the droplets ejected from each ejecting nozzle 24 will be described with reference to FIGS. 2A to 2D. FIGS. 2A to 2D are explanatory diagrams illustrating a relationship between the ejecting nozzles and the landing position of the droplet ejected from each ejecting nozzle. FIG. 2A is an explanatory diagram illustrating arrangement positions of the ejecting nozzles, FIG. 2B is an explanatory diagram illustrating a state where droplets are landed in a line shape in an extension direction of the nozzle row, FIG. 2C is an explanatory diagram illustrating a state where droplets are landed in a line shape in an ejection scanning direction, and FIG. 2D is an explanatory diagram illustrating a state where droplets are landed in a planar shape. In a state where the head unit 21 is mounted on the droplet ejecting apparatus 1, the X axis direction and the Y axis direction that are illustrated in FIGS. 2A to 2D are consistent with the X axis direction or the Y axis direction illustrated in FIGS. 1A and 1B. The X axis direction is an ejection scanning direction. The droplets can be landed in a certain position in the X axis direction by ejecting droplets the functional fluid in a certain position, while relatively moving the ejecting nozzles 24 (droplet ejecting head 20) in the directions of arrows a illustrated in FIGS. 2A to 2D.

As illustrated in FIG. 2A, the ejecting nozzles 24 constituting the nozzle row 24A are arranged with a distance between centers of the nozzle pitch P in the Y axis direction. As described above, the positions of the ejecting nozzles 24 respectively constituting each of two nozzle rows 24A are shifted with each other by half the nozzle pitch P in the Y axis direction.

As illustrated in FIG. 2B, a landing point 91 indicating a landing position and a landing circle 91A indicating a wetted and spread state of the droplet which is landed indicate a state of one droplet which is landed. A pattern in which the landing circles 91A are linearly connected to each other at the interval of half the nozzle pitch P between the centers is formed by ejecting the droplets, by ejecting respective droplets from the whole ejecting nozzles 24 of two nozzle rows 24A at a timing when droplets are landed on an imaginary line L indicated by the two-dot chain line in FIG. 2B.

As illustrated in FIG. 2C, a pattern in which landing circles 91A are linearly connected to each other in the X axis direction is formed by continuously ejecting droplets from one ejecting nozzle 24. A minimum value of the distance between centers of the landing points 91 in the X axis direction is referred to as a minimum landing distance d. The minimum landing distance d is a product of a relative movement speed in the X axis direction and a minimum ejection interval (time) of the ejecting nozzles 24.

As illustrated in FIG. 2D, a landing surface is formed by lines arranged in the X direction, which each connects the landing circles 91A at the interval of half the nozzle pitch P between the centers by ejecting respective droplets at a timing when droplets are landed on an imaginary lines L1, L2 and L3 indicated by the two-dot chain lines. In a case where distances between imaginary lines L1, L2 and L3 illustrated in FIG. 2D are the minimum landing distance d, respective landing points 91 are located at positions in which droplets of the functional fluid can be disposed by the droplet ejecting apparatus 1.

The positions on which the liquid droplets are arranged are set with respect to the positions of the respective landing points 91 illustrated in FIG. 2D, according to the information of the image when drawing the image. For example, a pixel arrangement drawing which designates arrangement positions and the ejecting nozzles 24 ejecting the droplets on the arrangement positions is formed. The image defined by the information of the image is drawn by landing the functional liquid according to the pixel arrangement drawing. In addition, although there is a gap between the landing circles 91A in the example illustrated in FIG. 2D, the functional fluid may be disposed without a gap by appropriately setting an ejection weight for one droplet of the droplets to be ejected, with respect to the nozzle pitch P or the minimum landing distance d. It is possible to form a mass in which a functional fluid is swollen at a predetermined region by disposing a functional fluid at the region. It is also possible to form a mass swollen by hardening the functional fluid. Needless to say, the liquid droplet of one droplet may be disposed independently without overlapping with other droplets.

### Virtual Image Displaying Decorative Body

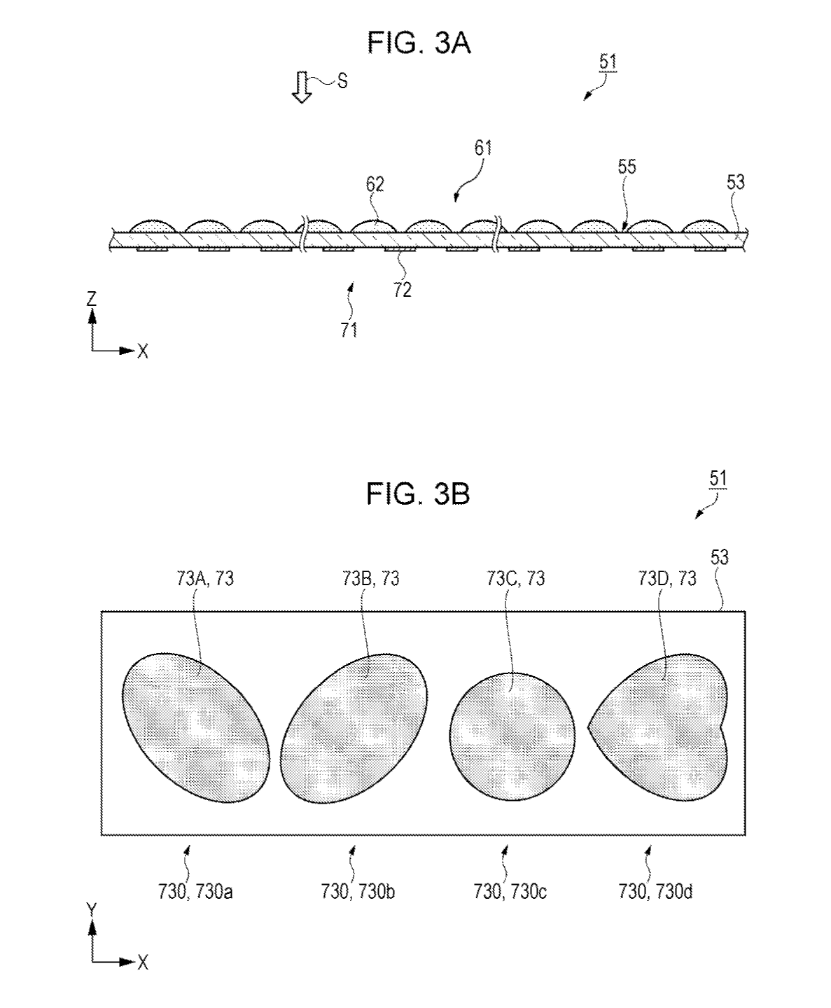

Next, a configuration of the virtual image displaying decorative body including a pixel array having pixel units and a lens array of micro-lenses will be described with reference to FIGS. 3A and 3B, 4A to 4F and 5A to 5F. FIGS. 3A and 3B are schematic diagrams of the configuration of the virtual image displaying decorative body. FIG. 3A is a cross-sectional diagram illustrating a main part of the virtual image displaying decorative body, and FIG. 3B is a schematic plan view illustrating virtual images made to appear on the virtual image displaying decorative body.

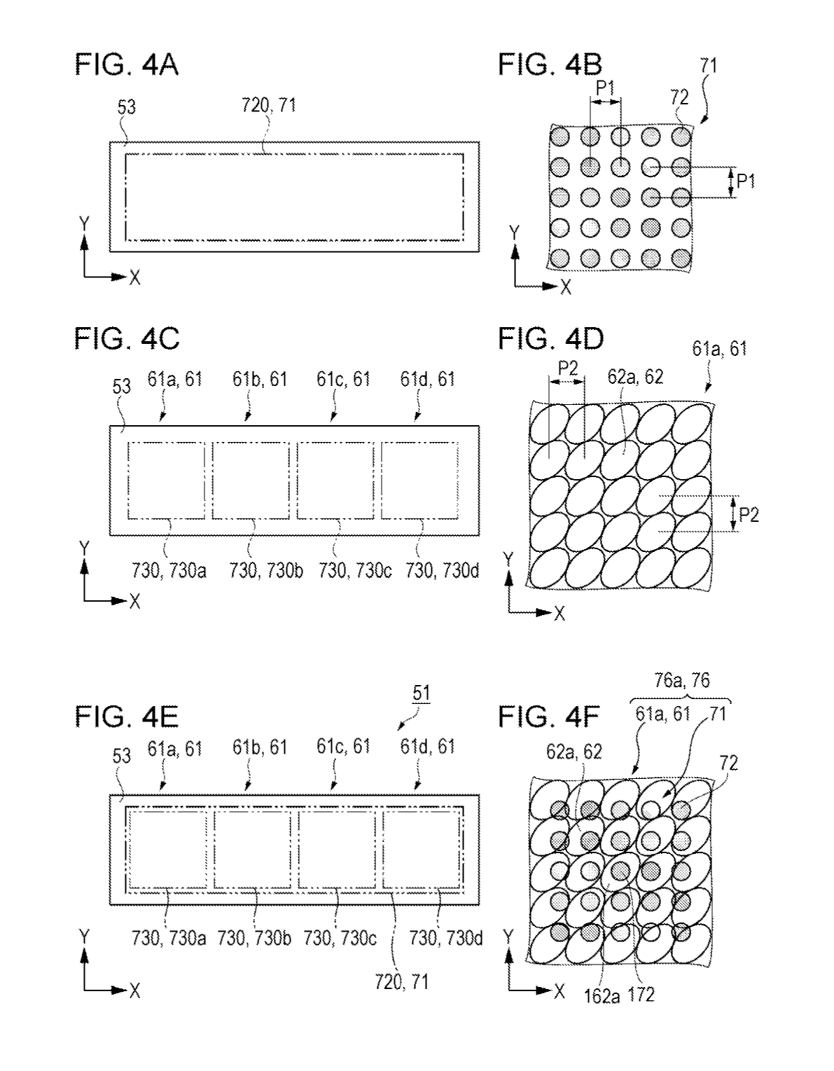

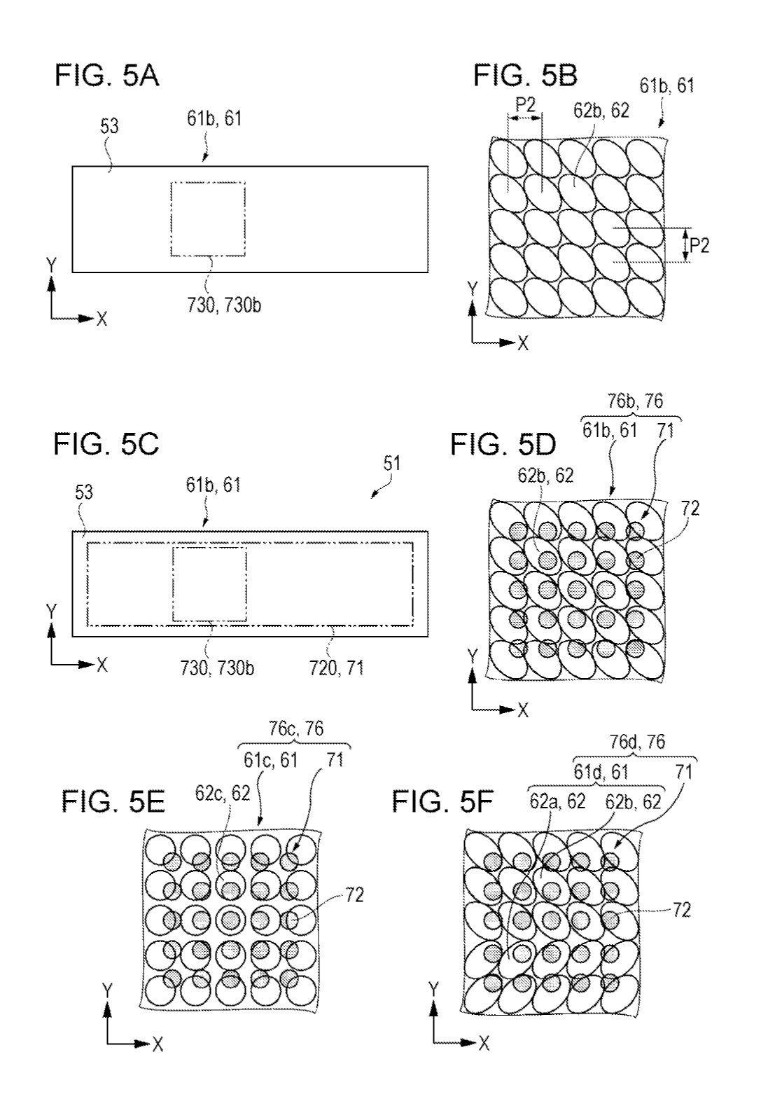

FIGS. 4A to 4F and 5A to 5F are schematic diagrams illustrating a configuration of elements constituting the virtual image displaying decorative body. FIG. 4A is a plan view illustrating a pixel array of the virtual image displaying decorative body, FIG. 4B is an enlarged plan view of the pixel array, FIG. 4C is a plan view illustrating virtual image regions of the virtual image displaying decorative body, FIG. 4D is an enlarged plan view of the lens array arranged in one of the virtual image regions illustrated in FIG. 4C, FIG. 4E is a plan view illustrating configurations of the virtual image regions and the pixel array of the virtual image displaying decorative body, and FIG. 4F is an enlarged plan view of the lens array and the pixel array that are arranged in one of the virtual image regions illustrated in FIG. 4E. FIG. 5A is a plan view illustrating the virtual image region of the virtual image displaying decorative body, FIG. 5B is an enlarged plan view of the lens array arranged in the virtual image region illustrated in FIG. 5A, FIG. 5C is a plan view illustrating configurations of the virtual image region and the pixel array of the virtual image displaying decorative body, FIG. 5D is an enlarged plan view of the lens array and the pixel array that are arranged in the virtual image region illustrated in FIG. 5C. FIGS. 5E and 5F are enlarged plan views of the lens array and the pixel array that are arranged in the virtual image region.

As illustrated in FIG. 3A, the virtual image displaying decorative body 51 includes a base member 53, a lens array 61, and a pixel array 71. The base member 53 is a film-shaped member made from a transparent material. The material of the base member 53 includes polyethylene (PE), polypropylene (PP), polyethylene terephthalate (PET), polycarbonate (PC), polyvinyl chloride (PVC), polyvinyl alcohols (PVA) and the like. A liquid repellent layer 55 is formed on one surface of the base member 53. Micro-lenses 62 constituting the lens array 61 are formed on the liquid repellent layer 55. The liquid repellent layer 55 is a layer having a liquid repellency with respect to the functional fluid for forming the micro-lens 62. The micro-lens 62 can be formed by disposing a functional fluid including materials of the micro-lens 62 with a predetermined amount at predetermined positions so as to form a predetermined plan view shape, using the droplet ejecting apparatus 1 described above.

The pixel units 72 constituting the pixel array 71 are formed on a surface opposite to the surface on which the liquid repellent layer 55 of the base member 53 is formed. The pixel unit 72 can be formed by disposing droplets of the functional fluid at predetermined positions using the droplet ejecting apparatus 1 described above so as to draw a predetermined shape.

When viewed from the direction of an arrow S illustrated in FIG. 3A, as illustrated in FIG. 3B, it is possible to visually recognize the pixel virtual image 73. In FIG. 3B, a shape A, a shape B, a shape C and a shape D are exemplified as pixel virtual images 73. The respective pixel virtual images 73 having the shape A, the shape B, the shape C and the shape D are respectively referred to as a pixel virtual image 73A, a pixel virtual image 73B, a pixel virtual image 73C, or a pixel virtual image 73D. A region in which one pixel virtual image 73 is made to appear is referred to as a virtual image region 730. Respective virtual image regions 730, in which the pixel virtual image 73A, the pixel virtual image 73B, the pixel virtual image 73C, and the pixel virtual image 73D are made to appear, are respectively referred to as a virtual image region 730a, a virtual image region 730b, a virtual image region 730c, or a virtual image region 730d.

A direction which is approximately parallel to the surface of the base member 53 and is approximately parallel to an arrangement direction of the virtual image regions 730 is referred to as an X axis direction, and a direction which is approximately parallel to the surface of the base member 53 and is orthogonal to the X axis direction is referred to as a Y axis direction. A direction which is orthogonal to the X axis direction and the Y axis direction is referred to as a Z axis direction.

The pixel array 71 is formed of pixel units 72 which are arranged at equal pitch in a lattice shape. The shape of the pixel unit 72 illustrated in FIG. 4B is approximately circular shape. The pixel units 72 are arranged in the X axis direction and the Y axis direction. An array of pixel units 72 formed in a virtual image region 730 is referred to as a pixel array 71, and an array of pixel units 72 formed in an entire virtual image displaying decorative body 51 is referred to as a pixel array 720. The pixel array 720 is formed in a region indicated by a two-dot chain line in FIG. 4A. As illustrated in FIG. 4B, the pixel units 72 are arranged at pitch P1 in rows and columns in the pixel array 720 (pixel array 71). For example, 2025 pixel units 72 are formed in 45 rows and 45 columns in the pixel array 71. The pitch P1 is, for example, 176 μm.

The region surrounded by a two-dot chain line illustrated in FIG. 4C indicates a virtual image region 730 at one place. One lens array 61 is formed in the virtual image region 730 at one place. The respective lens arrays 61 formed in a virtual image region 730a, a virtual image region 730b, a virtual image region 730c, and a virtual image region 730d are respectively referred to as a lens array 61a, a lens array 61b, a lens array 61c, and a lens array 61d.

The lens array 61 illustrated in FIG. 4D is the lens array 61a in which micro-lenses 62a are arranged at pitch P2. The micro-lenses 62 are arranged in the X axis direction and the Y axis direction. The micro-lens 62a has an elliptical shape in a plan view. In the micro-lens 62a, the longitudinal direction of the ellipse is inclined about 45 degrees clockwise with respect to the Y axis direction.

Since the micro-lens 62a has the elliptical shape, a magnification of an image varies depending on a direction of plan view. In the longitudinal direction of the ellipse, the radius of curvature of a lens surface is large, so that the focal length is long and magnification of the virtual image made to appear is small. The virtual image of the pixel unit 72 which is made to appear by the micro-lens 62a has a shape in which a circular shape is stretched in a direction substantially orthogonal to the longitudinal direction of the micro-lens 62a, as the pixel virtual image 73A illustrated in FIG. 3B. The micro-lens 62a has a magnification of several tens of times, so that the virtual image which can be visually recognized through one micro-lens 62a is a part of the virtual image of the pixel unit 72.

As illustrated in FIG. 4D, the micro-lenses 62 are arranged at pitch P2 in rows and columns in the lens array 61. The pitch P2 and the pitch P1 are set to values satisfying a relationship in which pitch P2×(the number of columns or the number of rows−1 of the micro-lenses 62 in the lens array 61)=pitch P1×(the number of columns or the number of rows of the pixel unit 72 in the pixel array 71). For example, 2025 pixel units 72 are formed in 45 rows and 45 columns in the pixel array 71. The pitch P2 is, for example, 180 μm.

As illustrated in FIG. 4E, in the virtual image displaying decorative body 51, the lens array 61 and the pixel array 71 of the pixel array 720 are formed by being overlapped in a direction parallel to a surface of a base member 53. A set of the lens array 61 and the pixel array 71, which makes a pixel virtual image 73 to appear is referred to as a virtual image unit 76. Respective virtual image units 76 which make a pixel virtual image 73A, a pixel virtual image 73B, a pixel virtual image 73C, and a pixel virtual image 73D to appear are respectively referred to as a virtual image unit 76a, a virtual image unit 76b, a virtual image unit 76c, and a virtual image unit 76d.

As illustrated in FIG. 4F, in the virtual image unit 76 (virtual image unit 76a), the center of the micro-lens 162a of the lens array 61a and the center of the pixel unit 172 of the pixel array 71 are consistent with each other. The micro-lens 162a is a micro-lens 62a located at the center of the lens array 61a, whereas the pixel unit 172 is the pixel unit 72 located at the center of the pixel array 71. With respect to the micro-lens 62a adjacent to the micro-lens 162a and the pixel unit 72 adjacent to the pixel unit 172, the center positions thereof are shifted by an amount corresponding to a difference between the pitch P1 and the pitch P2. In a case where the pitch P2 is 180 μm, and the pitch P1 is 176 μm, the center positions are shifted by 4 μm.

In the end of the virtual image unit 76, the center position of the pixel unit 72 constituting an end row or an end column, among rows and columns of pixel units 72 that the pixel array 71 includes, is located at the center point between the center position of the micro-lens 62 constituting an end row or an end column and the center position of the micro-lens 62 constituting a second row or a second column from the end, among rows and columns of micro-lenses 62 that the lens array 61 includes.

In this manner, a relative position between the micro-lens 62a of the lens array 61a and the pixel unit 72 of the pixel array 71 is shifted slightly. As described above, the virtual image which can be visually recognized through one micro-lens 62a is a part of the virtual image of the pixel unit 72. A part of the virtual image of the pixel unit 72 is made to appear by the micro-lens 62a corresponding to the pixel unit 72. Since the relative position between the micro-lens 62a and the pixel unit 72 is shifted slightly in the virtual image unit 76a, a different part of the pixel unit 72 is made to appear as a virtual image for each micro-lens 62 corresponding to the pixel unit 72 in the virtual image unit 76a. The virtual image which can be visually recognized through the lens array 61a is an array of virtual images which can be visually recognized through the micro-lens 62a that the lens array 61a includes, and is visually recognized as a shape of the pixel virtual image 73A. In this manner, in the virtual image units 76a arranged in the virtual image region 730a, the pixel virtual image 73A in which the pixel unit 72 is enlarged by the micro-lens 62a is made to appear in a manner capable of being visually recognized.

The pixel array 71 corresponds to a unit array. The micro-lens 62 corresponds to a light condensing element. The lens array 61 corresponds to a light condensing element array.

A region surrounded by a two-dot chain line, illustrated in FIG. 5A, indicates a virtual image region 730b. A lens array 61b is formed in the virtual image region 730b.

In the lens array 61b illustrated in FIG. 5B, micro-lenses 62b are arranged at pitch P2. The micro-lenses 62b are arranged in the X axis direction and the Y axis direction. The micro-lens 62b has the same shape as the micro-lens 62a, and has an elliptical shape in a plan view. In the micro-lens 62b, the longitudinal direction of the ellipse is inclined about 45 degrees counterclockwise with respect to the Y axis direction.

One of the micro-lens 62a and the micro-lens 62b corresponds to a first light condensing element, and the other thereof corresponds to a second light condensing element. The longitudinal direction of one of the micro-lens 62a and the micro-lens 62b corresponds to a first direction, and the longitudinal direction of the other thereof corresponds to a second direction.

As described above, a virtual image of the pixel unit 72 which is made to appear by the micro-lens 62a has a circular shape extended in a direction substantially orthogonal to the longitudinal direction of the micro-lens 62a, as the pixel virtual image 73A illustrated in FIG. 3B. Since the shape of the micro-lens 62b is the same as that of the micro-lens 62a, the virtual image of the pixel unit 72 which is made to appear by the micro-lens 62b is the same as that of the pixel virtual image 73A. However, since the micro-lens 62b is different from the micro-lens 62a in the longitudinal direction of the elliptical shape, the virtual image of the pixel unit 72 which is made to appear by the micro-lens 62b has a shape like the pixel virtual image 73B having different longitudinal direction from that of the pixel virtual image 73A. Similar to the micro-lens 62a, the micro-lens 62b has a magnification of several tens of times, so that the virtual image which can be visually recognized through one micro-lens 62b is a part of the virtual image of the pixel unit 72.

As illustrated in FIG. 5B, the micro-lenses 62b are arranged at pitch P2 in rows and columns in the lens array 61. The pitch P2 and the pitch P1 are set to values satisfying a relationship in which pitch P2×(the number of columns or the number of rows of the micro-lenses 62 in the lens array 61-1)=pitch P1×(the number of columns or the number of rows of the pixel unit 72 in the pixel array 71). For example, 2025 pixel units 72 are formed in 45 rows and 45 columns in the pixel array 71. The pitch P2 is, for example, 180 μm.

As illustrated in FIG. 5C, the lens array 61 and the pixel array 71 of the pixel array 720 are formed by being overlapped in a direction parallel to a surface of a base member 53, whereby the virtual image unit 76b is formed.

As illustrated in FIG. 5D, with respect to the pixel units 72 of the pixel array 71, the micro-lens 62b of the lens array 61b in the virtual image unit 76b are arranged in the same manner as the micro-lens 62a of the lens array 61a in the virtual image unit 76a.

Similar to the virtual image unit 76a, the virtual image which can be visually recognized through the lens array 61b in the virtual image unit 76b is an array of the virtual images which can be visually recognized through the micro-lens 62b that the lens array 61b includes. In the virtual image unit 76b arranged in the virtual image region 730b, the pixel virtual image 73B, in which the pixel unit 72 is enlarged by the micro-lens 62b, is made to visibly appear.

FIG. 5E is an enlarged plan view of the lens array 61c and the pixel array 71 which constitute the virtual image units 76c arranged in the virtual image region 730c. In the lens array 61c shown in the FIG. 5E, the micro-lenses 62c are arranged at pitch P2. The micro-lenses 62c are arranged in the X axis direction and the Y axis direction. The micro-lens 62c has approximately circular shape in a plan view.

One of the micro-lens 62a and the micro-lens 62b corresponds to a third light condensing element, and the micro-lens 62c corresponds to a fourth light condensing element. The plan view of one of the micro-lens 62a and the micro-lens 62b corresponds to a first ellipse.

A virtual image of the pixel unit 72 which is made to appear by the micro-lens 62c having approximately circular shape in a plan view has an approximately circular shape as the pixel virtual image 73C illustrated in FIG. 3B. The micro-lens 62c has a magnification of several tens of times similar to the micro-lens 62a and the like, so that the virtual image which can be visually recognized through one micro-lens 62c is a part of the virtual image of the pixel unit 72.

An arrangement of the micro-lenses 62c in the lens array 61c is the same as the arrangement of the micro-lens 62b in the lens array 61b. The relative position between the pixel unit 72 and the micro-lens 62c in the virtual image unit 76c is the same as the relative position between the pixel unit 72 and the micro-lens 62a in the virtual image unit 76a and the relative position between the pixel unit 72 and the micro-lens 62b in the virtual image unit 76b.

Similar to the virtual image unit 76a or the like, in the virtual image unit 76c, the virtual image which can be visually recognized through the lens array 61c is an array of virtual images which can be visually recognized through the micro-lens 62c that the lens array 61c includes. In the virtual image units 76c arranged in the virtual image region 730c, the pixel virtual image 73C in which the pixel units 72 are enlarged by the micro-lens 62c is made to visibly appear.

FIG. 5F is an enlarged plan view of the lens array 61d and the pixel array 71 which constitute the virtual image units 76d arranged in the virtual image region 730d.

As illustrated in FIG. 5F, the lens array 61d includes the micro-lens 62a and the micro-lens 62b. In the lens array 61d, the micro-lenses 62b are arranged in an upper half portion of FIG. 5F, and the micro-lenses 62a are arranged in a lower half portion of FIG. 5F. The lens array 61d corresponds to the first light condensing element array.

The arrangement of the micro-lens 62a and the micro-lens 62b in the lens array 61d is the same as the arrangement of the micro-lens 62a in the lens array 61a, or the arrangement of the micro-lens 62b in the lens array 61b.

The virtual image made to appear by the micro-lens 62a and the micro-lens 62b in the lens array 61d is the same as the virtual image made to appear by the micro-lens 62a in the lens array 61a or the virtual image made to appear by the micro-lens 62b in the lens array 61b.

The virtual image which can be visually recognized through the lens array 61d in the virtual image unit 76d is a virtual image in which a side in which the micro-lenses 62b are arranged is a half portion of the pixel virtual image 73A, and a side in which the micro-lenses 62a are arranged is a half portion of the pixel virtual image 73B. In the virtual image units 76d arranged in the virtual image region 730d, the pixel virtual image 73D is made to visibly appear through the lens array 61d.

### Another Configuration Example 1 of Lens Array

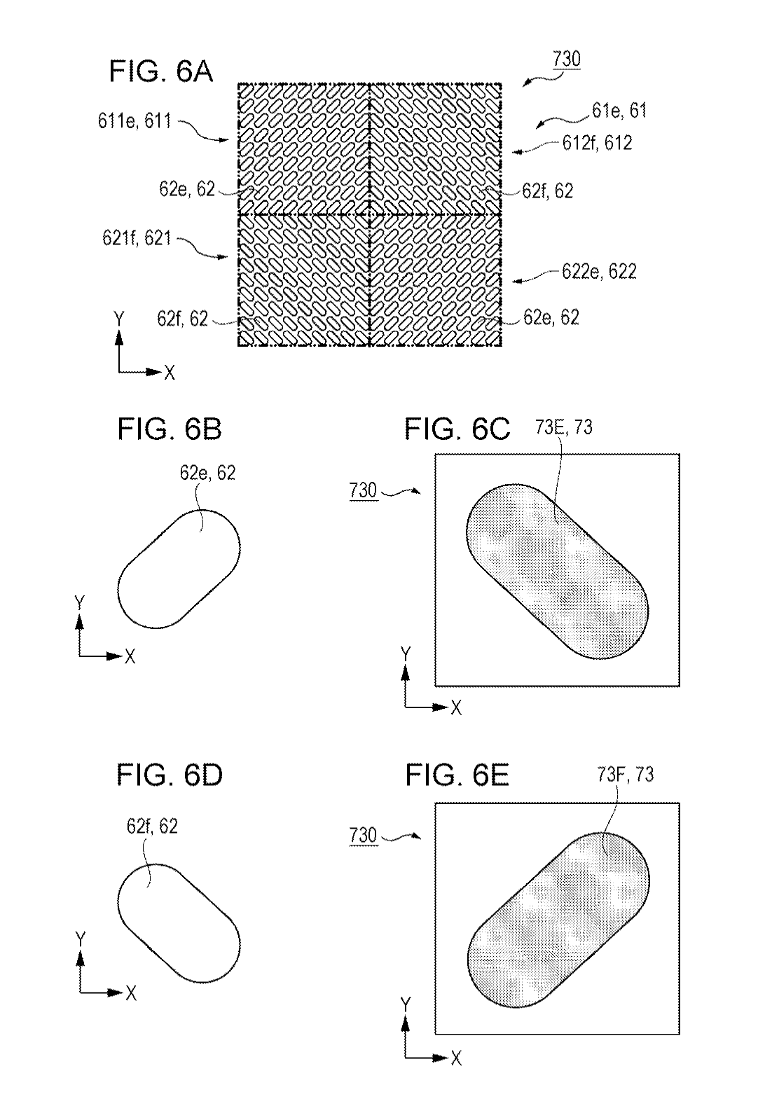

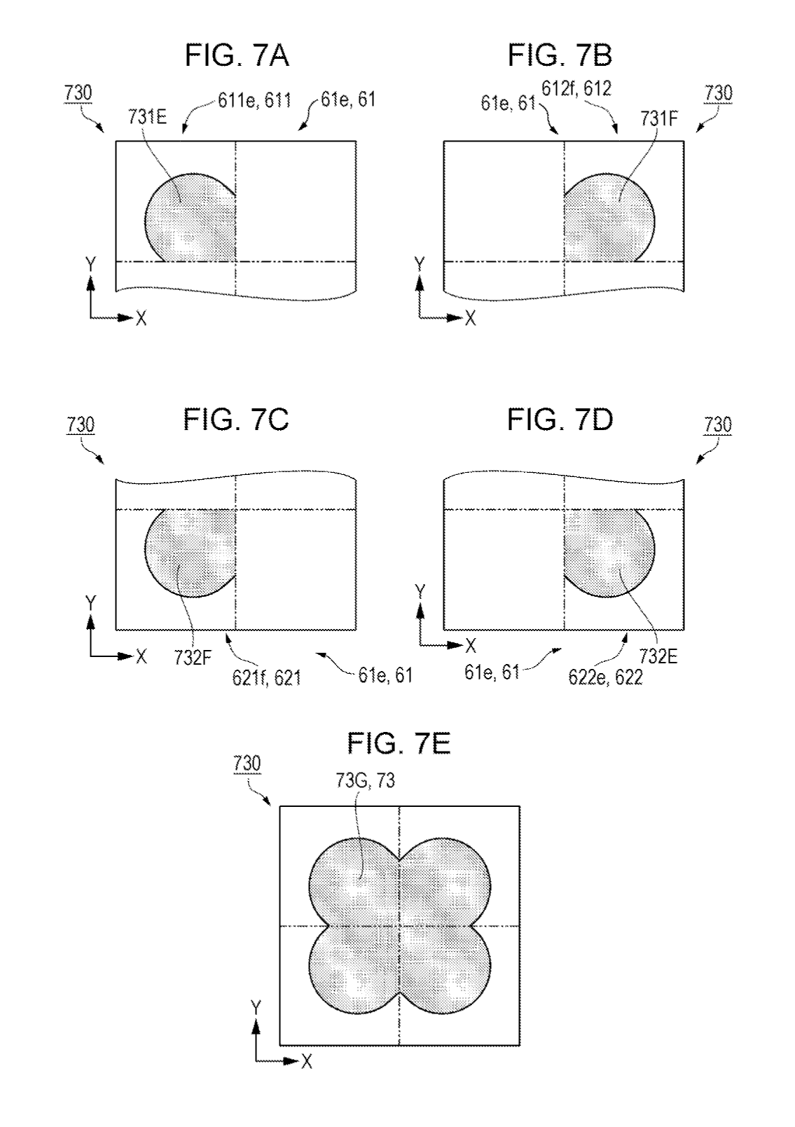

Next, the lens array 61e in which a configuration of the micro-lens 62 included is different from that of the lens array 61a described above and the pixel virtual image 73G made to appear by the lens array 61e will be described with reference to FIGS. 6A to 6E and 7A to 7E. FIGS. 6A to 6E are explanatory diagrams illustrating a configuration of a lens array. FIGS. 7A to 7E are explanatory diagrams illustrating shapes of virtual images made to appear. FIG. 6A is a plan view illustrating an arrangement of micro-lenses in the lens array, FIG. 6B is a plan view illustrating a shape of the micro-lens, and FIG. 6C is an explanatory diagram illustrating a shape of a virtual image made to appear by the micro-lens illustrated in FIG. 6B. FIG. 6D is a plan view illustrating the shape of the micro-lens, and FIG. 6E is an explanatory diagram illustrating a shape of a virtual image made to appear by the micro-lens illustrated in FIG. 6D. FIGS. 7A to 7D are explanatory diagrams illustrating a shape of the virtual image made to appear by a sub-lens array, and FIG. 7E is an explanatory diagram illustrating a shape of the virtual image made to appear by the micro-lens array illustrated in FIG. 6A.

As illustrated in FIG. 6A, the lens array 61e includes a micro-lens 62e and a micro-lens 62f. In FIG. 6A obtained by dividing the lens array 61e into four, an upper left part in FIG. 6A is referred to as a sub-lens array 611, an upper right part is referred to as a sub-lens array 612, a lower left part is referred to as a sub-lens array 621, and a lower right part is referred to as a sub-lens array 622. The micro-lenses 62e are arranged in the sub-lens array 611 and the sub-lens array 622. The sub-lens array 611 and the sub-lens array 622 including the micro-lenses 62e are respectively referred to as a sub-lens array 611e or a sub-lens array 622e. The micro-lenses 62f are arranged in the sub-lens array 612 and the sub-lens array 621. The sub-lens array 612 and the sub-lens array 621 including the micro-lenses 62f are respectively referred to as a sub-lens array 612f or a sub-lens array 621f.

One of the micro-lens 62e and the micro-lens 62f corresponds to the first light condensing element, and the other thereof corresponds to the second light condensing element. The longitudinal direction of one of the micro-lens 62e and the micro-lens 62f corresponds to a first direction, and the longitudinal direction of the other thereof corresponds to a second direction. The lens array 61e corresponds to a first light condensing element array.

As illustrated in FIG. 6B, a plan view shape of the micro-lens 62e has a so-called track shape which is formed of two half circles and lines connecting ends of the two half circles. In the micro-lens 62e, the longitudinal direction of the track shape is inclined about 45 degrees clockwise with respect to the Y axis direction.

Since the micro-lens 62e has the track shape, the enlargement factor of an image varies depending on a direction of plan view. The radius of curvature of a lens surface is large, so that the focal length is long in the longitudinal direction of the track shape and magnification of the virtual image made to appear is small. The virtual image of the pixel array 71 which is made to appear by the lens array 61 configured by micro-lenses 62e has a shape, for example, like the pixel virtual image 73E illustrated in FIG. 6C. The pixel virtual image 73E has a shape in which a circular shape is stretched in a direction substantially orthogonal to the longitudinal direction of the micro-lens 62e.

As illustrated in FIG. 6D, a plan view shape of the micro-lens 62f has a track shape similar to the micro-lens 62e. In the micro-lens 62f, the longitudinal direction of the track shape is inclined about 45 degrees counterclockwise with respect to the Y axis direction.

Similar to a case of the micro-lens 62e, the virtual image of the pixel array 71 which is made to appear by the lens array 61 configured by micro-lenses 62f has a shape, for example, like the pixel virtual image 73F illustrated in FIG. 6E. The pixel virtual image 73F has a shape in which a circular shape is stretched in a direction substantially orthogonal to the longitudinal direction of the micro-lens 62f.

The virtual image of the pixel array 71 which is made to appear by the sub-lens array 611, as illustrated in FIG. 7A, has a shape like a pixel virtual image 731E corresponding to a part overlapping with the sub-lens array 611, in the pixel virtual image 73E.

The virtual image of the pixel array 71 which is made to appear by the sub-lens array 612, as illustrated in FIG. 7B, has a shape like a pixel virtual image 731F corresponding to a part overlapping with the sub-lens array 612, in the pixel virtual image 73F.

The virtual image of the pixel array 71 which is made to appear by the sub-lens array 621, as illustrated in FIG. 7C, has a shape like a pixel virtual image 732F corresponding to a part overlapping with the sub-lens array 621, in the pixel virtual image 73F.

The virtual image of the pixel array 71 which is made to appear by the sub-lens array 622, as illustrated in FIG. 7E, has a shape like a pixel virtual image 731E corresponding to a part overlapping with the sub-lens array 622, in the pixel virtual image 73E.

The virtual image of the pixel array 71 which is made to appear by the lens array 61e includes the pixel virtual image 731E, the pixel virtual image 731F, the pixel virtual image 732F and the pixel virtual image 732E. The virtual image of the pixel array 71 is made to appear by the lens array 61e, whereby a virtual image like the virtual image 73G illustrated in FIG. 7E is made to visibly appear.

### Another Configuration Example 2 of Lens Array

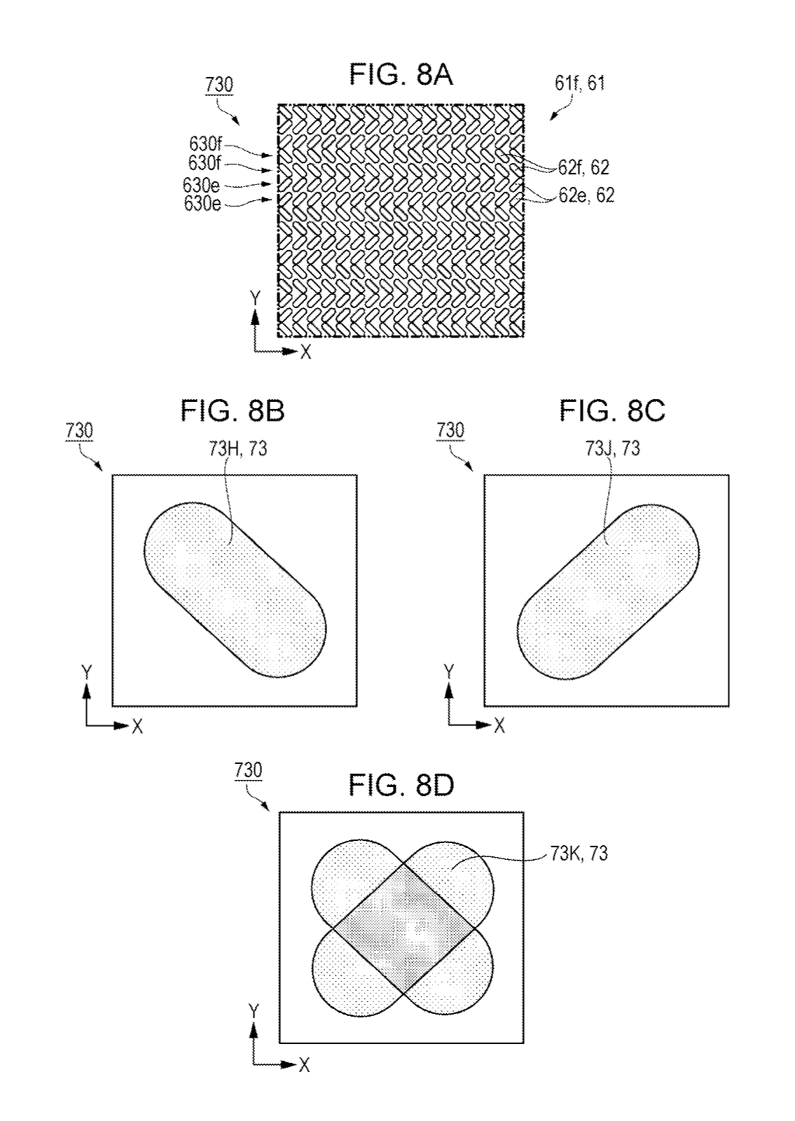

Next, the lens array 61f in which a configuration of the micro-lenses 62 included is different from that of the lens array 61a described above, and the pixel virtual image 73K made to appear by the lens array 61f will be described with reference to FIGS. 8A to 8D. FIGS. 8A to 8D are explanatory diagrams illustrating a configuration of a lens array and the virtual image made to appear. FIG. 8A is a plan view illustrating an arrangement of the micro-lenses in the lens array, FIGS. 8B and 8C are explanatory diagrams illustrating shapes of virtual images made to appear by a part of the micro-lenses illustrated in FIG. 8A, and FIG. 8D is an explanatory diagram illustrating a shape of a virtual image made to appear by the micro-lens array illustrated in FIG. 8A.

As illustrated in FIG. 8A, the lens array 61f includes micro-lenses 62e and micro-lenses 62f. The micro-lenses 62e and the micro-lens 62f are the micro-lens 62e and the micro-lens 62f included in the lens array 61e described above. The lens array 61f includes lens rows 630e in which micro-lenses 62e are arranged in the X axis direction and lens rows 630f in which micro-lenses 62f are arranged in the X axis direction. In the lens array 61f, two lens rows 630e and two lens rows 630f are alternately arranged in the Y axis direction.

One of the micro-lens 62e and the micro-lens 62f corresponds to the first light condensing element, and the other thereof corresponds to the second light condensing element. The longitudinal direction of one of the micro-lens 62e and the micro-lens 62f corresponds to the first direction, and the longitudinal direction of the other thereof corresponds to the second direction. The lens array 61f corresponds to the first light condensing element array. The lens row 630e and the lens row 630f are configured by for example, 45 micro-lenses 62e or micro-lenses 62f. The lens array 61f includes together lens rows 630e and the lens row 630f of, for example, 45 rows.

The virtual image of the pixel array 71 which is made to appear by the micro-lenses 62e included in the lens array 61f has a shape like a pixel virtual image 73H illustrated in FIG. 8B. As described above, the virtual image of the pixel array 71 which is made to appear by the lens array 61f configured by micro-lenses 62e has a shape for example, like the pixel virtual image 73E illustrated in FIG. 6C.

The virtual image of the pixel unit 72 which is made to appear by one micro-lens 62 is referred to as a lens virtual image. The number of micro-lenses 62e included in the lens array 61f is approximately half the number of micro-lenses 62e included in the lens array 61 configured by the micro-lenses 62e. Accordingly, the pixel virtual image 73H is configured by a lens virtual image of approximately half the number compared to the pixel virtual image 73E, the pixel virtual image 73H is visually recognized such that for example, the gradation is different from the pixel virtual image 73E.

The virtual image of the pixel array 71 which is made to appear by the micro-lenses 62f included in the lens array 61f has a shape like a pixel virtual image 73J illustrated in FIG. 8C. As described above, the virtual image of the pixel array 71 which is made to appear by the lens array 61 configured by micro-lenses 62f has a shape for example, like the pixel virtual image 73F illustrated in FIG. 6E.

Similar to the pixel virtual image 73E, the pixel virtual image 73J is visually recognized such that for example, the gradation is different from the pixel virtual image 73F.

The virtual image of the pixel array 71 which is made to appear by the lens array 61f includes the pixel virtual image 73H and the pixel virtual image 73J. The pixel virtual image 73K illustrated in FIG. 8D has a shape including the pixel virtual image 73H and the pixel virtual image 73J. By causing the virtual image of the pixel array 71 to appear by the lens array 61f, the virtual image like the pixel virtual image 73K is made to visibly appear.

### Another Configuration Example 3 of Lens Array

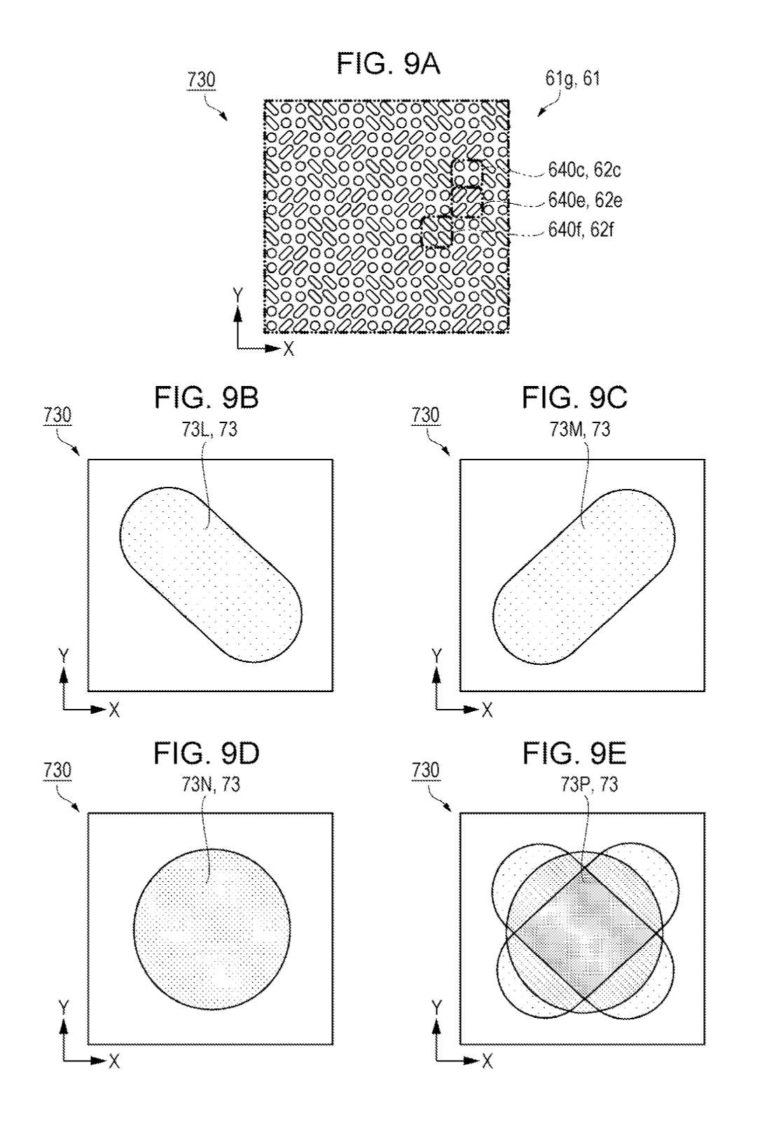

Next, the lens array 61g in which a configuration of the included micro-lens 62 is different from that of the lens array 61a described above and the pixel virtual image 73P made to appear by the lens array 61g will be described with reference to FIGS. 9A to 9E. FIGS. 9A to 9E are explanatory diagrams illustrating a configuration of a lens array and a pixel virtual image made to appear. FIG. 9A is a plan view illustrating an arrangement of the micro-lenses in the lens array, FIGS. 9B, 9C and 9D are explanatory diagrams illustrating shapes of virtual images made to appear by a part of the micro-lenses illustrated in FIG. 9A, and FIG. 9E is an explanatory diagram illustrating a shape of a virtual image made to appear by the micro-lens array illustrated in FIG. 9A.

As illustrated in FIG. 9A, the lens array 61g includes micro-lenses 62c, micro-lenses 62e and micro-lenses 62f. The micro-lens 62c is the micro-lens 62c included in the lens array 61c described above. The micro-lens 62e and the micro-lens 62f are the micro-lens 62e and the micro-lens 62f that are included in the lens array 61e described above.

One of the micro-lens 62e, the micro-lens 62f and the micro-lens 62c corresponds to the third light condensing element, and the others thereof correspond to the fourth light condensing element. The plan view shape of any one of the micro-lens 62e, the micro-lens 62f and the micro-lens 62c corresponds to an ellipse. The lens array 61g corresponds to the second light condensing element array.

A mass of four micro-lenses 62 is referred to as a lens mass 640. The lens array 61g includes a lens mass 640c configured by four micro-lenses 62c, a lens mass 640e configured by four micro-lenses 62e, and a lens mass 640f configured by four micro-lenses 62f. In the lens array 61g, the lens mass 640c and the lens mass 640e are alternately arranged in the X axis direction and the Y axis direction. The lens mass 640c and the lens mass 640f are alternately arranged in the X axis direction and the Y axis direction. The lens mass 640c is arranged on both sides of the lens mass 640e and the lens mass 640f in the X axis direction and the Y axis direction. In a case where the lens mass 640e is arranged on both sides of the lens mass 640c in the X axis direction, the lens mass 640f is arranged on both sides of the lens mass 640c in the Y axis direction.

The lens array 61g is formed by, for example, forty fives micro-lenses 62 that are arranged side by side in the X axis direction and the Y axis direction.

The virtual image of the pixel array 71 which is made to appear by the micro-lenses 62e included in the lens array 61g has a shape like a pixel virtual image 73L illustrated in FIG. 9B. As described above, the virtual image of the pixel array 71 which is made to appear by the lens array 61 configured by micro-lenses 62e has a shape for example, like the pixel virtual image 73E illustrated in FIG. 6C.

The number of micro-lenses 62e included in the lens array 61g is approximately ¼ the number of micro-lenses 62e included in the lens array 61 that is configured by the micro-lenses 62e. Accordingly, the pixel virtual image 73L is configured by a lens virtual image of approximately ¼ the number compared to the pixel virtual image 73E, and the pixel virtual image 73L is visually recognized such that for example, the gradation is different from the pixel virtual image 73E.

The virtual image of the pixel array 71 which is made to appear by the micro-lenses 62f included in the lens array 61g has a shape like a pixel virtual image 73M illustrated in FIG. 9C. As described above, the virtual image of the pixel array 71 which is made to appear by the lens array 61 configured by micro-lenses 62f has a shape for example, like the pixel virtual image 73F illustrated in FIG. 6E.

Similar to the pixel virtual image 73L, the pixel virtual image 73M is visually recognized such that for example, the gradation is different from the pixel virtual image 73F.

The virtual image of the pixel array 71 which is made to appear by the micro-lenses 62c included in the lens array 61g has a shape like a pixel virtual image 73N illustrated in FIG. 9D. As described above, the virtual image of the pixel array 71 which is made to appear by the lens array 61 configured by micro-lenses 62c has a shape for example, like the pixel virtual image 73C illustrated in FIG. 3B.

The number of micro-lenses 62c included in the lens array 61g is approximately half the number of micro-lenses 62c included in the lens array 61 that is configured by the micro-lenses 62c. Accordingly, the pixel virtual image 73N is configured by a lens virtual image of approximately half the number compared to the pixel virtual image 73C, and the pixel virtual image 73N is visually recognized such that for example, the gradation is different from the pixel virtual image 73C.

The virtual image of the pixel array 71 which is made to appear by the lens array 61g includes the pixel virtual image 73L, the pixel virtual image 73M and the pixel virtual image 73N. The pixel virtual image 73P illustrated in FIG. 9E has a shape including the pixel virtual image 73L, the pixel virtual image 73M and the pixel virtual image 73N. By causing the virtual image of the pixel array 71 to appear by the lens array 61g, the virtual image like the pixel virtual image 73P is made to visibly appear.

### Another Configuration Example of Virtual Image Displaying Decorative Body

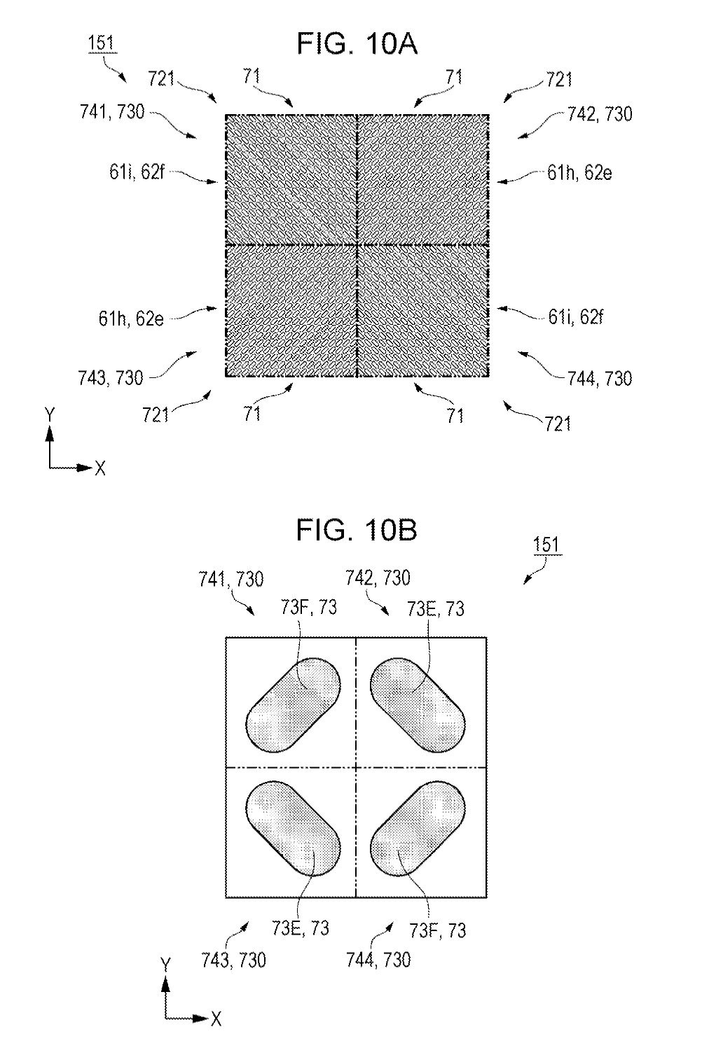

Next, a configuration of a lens array 61 of a virtual image displaying decorative body 151 having a different configuration of a lens array 61 included in the virtual image displaying decorative body 51 and a virtual image made to appear on the virtual image displaying decorative body will be described with reference to FIGS. 10A to 12B.

First, the configuration of the lens array 61 of the virtual image displaying decorative body 151 and the virtual image made to appear on the virtual image displaying decorative body 151 will be described with reference to FIGS. 10A and 10B. FIGS. 10A and 10B are explanatory diagrams illustrating the configuration of the lens array of the virtual image displaying decorative body and the virtual image made to appear. FIG. 10A is an explanatory diagram illustrating the configuration of the lens array of the virtual image displaying decorative body, and FIG. 10B is a plan view illustrating a shape of a virtual image made to appear.

As illustrated in FIG. 10A, the virtual image displaying decorative body 151 includes four virtual image regions 730. The four virtual image regions 730 are respectively referred to as a virtual image region 741, a virtual image region 742, a virtual image region 743, and a virtual image region 744. The virtual image region 741 and the virtual image region 742, and the virtual image region 743 and the virtual image region 744 are arranged in the X axis direction, and the virtual image region 741 and the virtual image region 743, and the virtual image region 742 and the virtual image region 744 are arranged in the Y axis direction.

A lens array 61i configured by micro-lenses 62f is arranged in the virtual image region 741. A lens array 61h configured by micro-lenses 62e is arranged in the virtual image region 742. A lens array 61h is arranged in the virtual image region 743 similar to the virtual image region 742. A lens array 61i is arranged in the virtual image region 744 similar to the virtual image region 741.

Any one of the micro-lens 62e and the micro-lens 62f corresponds to the first light condensing element, and the other thereof corresponds to the second light condensing element. The longitudinal direction of any one of the micro-lens 62e and the micro-lens 62f corresponds to the first direction, and the longitudinal direction of the other thereof corresponds to the second direction. Any one of the lens array 61h and the lens array 61i corresponds to the third light condensing element array, and the other thereof corresponds to the fourth light condensing element array.

The virtual image displaying decorative body 151 includes a pixel array 721 including a pixel array 71 corresponding to each of the virtual image region 730. In the pixel array 721, pixel units 72 are arranged two-dimensionally at a predetermined spacing, in a range including the virtual image region 741, the virtual image region 742, the virtual image region 743, and the virtual image region 744. The arrangement of the pixel unit 72 in the pixel array 721 is uniform, and a division of the pixel array 71 is not clear. In the pixel array 721, a part corresponding to the lens array 61 is the pixel array 71.

As illustrated in FIG. 10B, the pixel virtual image 73F illustrated in FIG. 6E is made to appear in the virtual image region 741 and the virtual image region 744 in which the lens array 61i is arranged. The pixel virtual image 73E illustrated in FIG. 6C is made to appear in the virtual image region 742 and the virtual image region 743 in which the lens array 61h is arranged.

A virtual image of which a center is surrounded by two pixel virtual images 73E and two pixel virtual images 73F in the virtual image displaying decorative body 151.

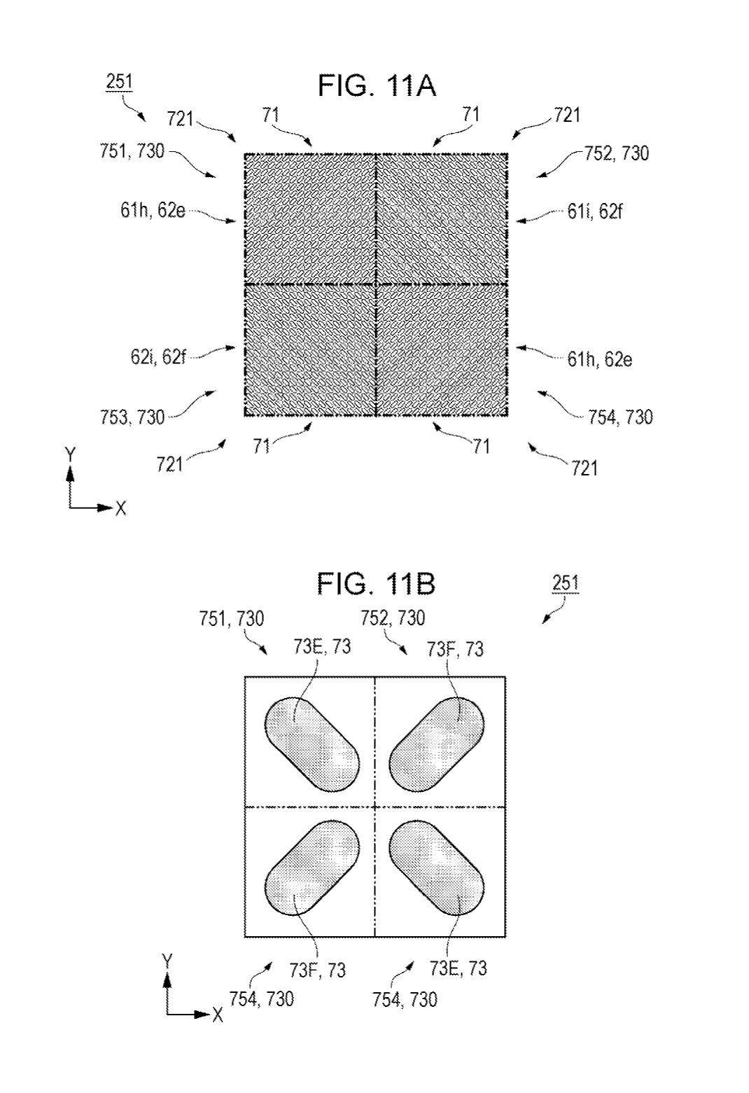

Next, the configuration of the lens array 61 of the virtual image displaying decorative body 251 and the virtual image made to appear on the virtual image displaying decorative body 251 will be described with reference to FIGS. 11A and 11B. FIGS. 11A and 11B are explanatory diagrams illustrating the configuration of the lens array of the virtual image displaying decorative body and the virtual image made to appear. FIG. 11A is an explanatory diagram illustrating the configuration of the lens array of the virtual image displaying decorative body, and FIG. 11B is a plan view illustrating a shape of a virtual image made to appear.

As illustrated in FIG. 11A, the virtual image displaying decorative body 251 includes four virtual image regions 730. The four virtual image regions 730 are respectively referred to as a virtual image region 751, a virtual image region 752, a virtual image region 753, and a virtual image region 754. A pair of the virtual image region 751 and the virtual image region 752, and a pair of the virtual image region 753 and the virtual image region 754 are arranged in the X axis direction, and a pair of the virtual image region 751 and the virtual image region 753, and a pair of the virtual image region 752 and the virtual image region 754 are arranged in the Y axis direction.

A lens array 61h configured by micro-lenses 62e is arranged in the virtual image region 751. A lens array 61i configured by micro-lenses 62f is arranged in the virtual image region 752. A lens array 61i is arranged in the virtual image region 753 similar to the virtual image region 752. A lens array 61h is arranged in the virtual image region 754 similar to the virtual image region 751. Any one of the lens array 61h and the lens array 61i corresponds to the third light condensing element array, and the other thereof corresponds to the fourth light condensing element array.

The virtual image displaying decorative body 251, similar to the virtual image displaying decorative body 151, includes the pixel array 721 including the pixel array 71 corresponding to each virtual image region 730. In the pixel array 721, the part corresponding to the lens array 61 is the pixel array 71.

As illustrated in FIG. 11B, the pixel virtual image 73F illustrated in FIG. 6E is made to appear in the virtual image region 752 and the virtual image region 753 in which the lens array 61i is arranged. The pixel virtual image 73E illustrated in FIG. 6C is made to appear in the virtual image region 751 and the virtual image region 754 in which the lens array 61h is arranged.

In the virtual image displaying decorative body 251, a virtual image, in which two pixel virtual images 73E and two pixel virtual images 73F are arranged radially from a center portion, is made to appear.

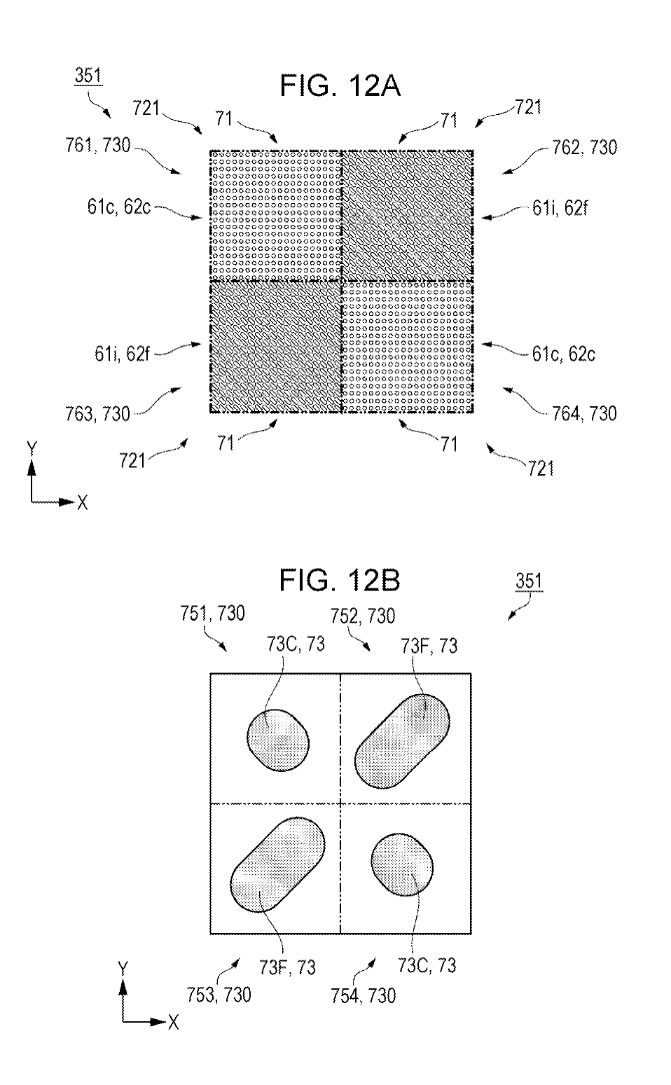

Next, the configuration of the lens array 61 of the virtual image displaying decorative body 351 and the virtual image made to appear on the virtual image displaying decorative body 351 will be described with reference to FIGS. 12A and 12B. FIGS. 12A and 12B are explanatory diagrams illustrating the configuration of the lens array of the virtual image displaying decorative body and the virtual image made to appear. FIG. 12A is an explanatory diagram illustrating the configuration of the lens array of the virtual image displaying decorative body, and FIG. 12B is a plan view illustrating a shape of a virtual image made to appear.

As illustrated in FIG. 12A, the virtual image displaying decorative body 351 includes four virtual image regions 730. The four virtual image regions 730 are respectively referred to as a virtual image region 761, a virtual image region 762, a virtual image region 763, and a virtual image region 764. A pair of the virtual image region 761 and the virtual image region 762, and a pair of the virtual image region 763 and the virtual image region 764 are arranged in the X axis direction, and a pair of the virtual image region 761 and the virtual image region 763, and a pair of the virtual image region 762 and the virtual image region 764 are arranged in the Y axis direction.

A lens array 61c configured by micro-lenses 62c is arranged in the virtual image region 761. A lens array 61i configured by micro-lenses 62f is arranged in the virtual image region 762. A lens array 61i is arranged in the virtual image region 763 similar to the virtual image region 762. A lens array 61c is arranged in the virtual image region 764 similar to the virtual image region 761.

One of the micro-lens 62f and the micro-lens 62c corresponds to the third light condensing element, and the other thereof corresponds to the fourth light condensing element. The plan view shape of any one of the micro-lens 62f and the micro-lens 62c corresponds to the first ellipse. One of the lens array 61c and the lens array 61i corresponds to the fifth light condensing element array, and the other thereof corresponds to the sixth light condensing element array.

The virtual image displaying decorative body 351, similar to the virtual image displaying decorative body 151, includes the pixel array 721 including the pixel array 71 corresponding to each virtual image region 730. In the pixel array 721, the part corresponding to the lens array 61 is the pixel array 71.

As illustrated in FIG. 12B, the pixel virtual image 73F illustrated in FIG. 6E is made to appear in the virtual image region 762 and the virtual image region 763 in which the lens arrays 61i are arranged. The pixel virtual image 73C illustrated in FIG. 3B is made to appear in the virtual image region 761 and the virtual image region 764 in which the lens arrays 61c are arranged.

A virtual image, in which two pixel virtual images 73F are arranged in an inclined straight line and pixel virtual images 73C are arranged one by one across the two pixel virtual images 73F in the straight line, is made to appear in the virtual image displaying decorative body 351.

Hereinafter, effects according to the exemplary embodiment are described. According to the exemplary embodiment, the following effects can be obtained.

(1) The pixel array 71 is formed by pixel units 72 being arranged at equal pitch intervals in a lattice shape. The lens array 61 is formed by micro-lenses 62 being arranged at equal pitch intervals in a lattice shape at positions associated with the positions of the pixel units 72. Accordingly, it is possible to make an enlarged virtual image of the pixel array 71 to appear by the lens array 61. It is possible to shape the virtual image to be visually recognized as an image in which one pixel unit 72 is enlarged.

(2) The micro-lens 62 has an ellipse shape in a plan view, and a distance from a center to an end varies depending on a position in a circumferential direction. That is, in the micro-lens 62, the cross-sectional shape including an optical axis passing through the center varies depending on the position of the end of the cross section in the circumferential direction. Accordingly, the magnification of the virtual image made to appear is different at each cross section. For this reason, the virtual image of the pixel unit 72 made to appear by the micro-lens 62 has a shape in which the plan view shape of the pixel unit 72 is deformed. Accordingly, it is possible to make a virtual image to appear, which is different from that of the pixel unit 72. Further, the shape of the micro-lens 62 changes, so that it is possible to make a virtual image to appear, which has a different shape depending on the shape of the micro-lens 62.

(3) The virtual image displaying decorative body 51 includes a virtual image region 730a, a virtual image region 730b, a virtual image region 730c, and a virtual image region 730d. A lens array 61a, a lens array 61b, a lens array 61c, or a lens array 61d is formed in a virtual image region 730a, a virtual image region 730b, a virtual image region 730c, and a virtual image region 730d. The lens array 61a, the lens array 61b, the lens array 61c, and the lens array 61d have different micro-lenses 62 from each other. Accordingly, it is possible to make a pixel virtual image 73A, a pixel virtual image 73B, a pixel virtual image 73C, or a pixel virtual image 73D to appear, of which shapes to be viewed are different from each other, in the virtual image region 730a, the virtual image region 730b, the virtual image region 730c, and the virtual image region 730d that include pixel arrays 71 including pixel units 72 having the same shape.

(4) The lens array 61d, the lens array 61e, and the lens array 61f include a micro-lens 62a and a micro-lens 62b, or a micro-lens 62e and a micro-lens 62f, of which the longitudinal directions of ellipses are different. Accordingly, the lens array 61d makes a pixel virtual image 73D to appear, which is configured by a virtual image made to appear by the micro-lens 62a and a virtual image made to appear by the micro-lens 62b. The lens array 61e and the lens array 61f can make a pixel virtual image 73G or a pixel virtual image 73K to appear, which is configured by a virtual image made to appear by the micro-lens 62e and a virtual image made to appear by the micro-lens 62f. Further, it is possible to make pixel virtual images 73 that are different from each other to appear, as the pixel virtual image 73G and the pixel virtual image 73K, depending on arrangement positions of two kinds of micro-lens 62.

(5) The lens array 61g includes the micro-lens 62c having a different plan view shape, in addition to the micro-lens 62a and the micro-lens 62b of which the longitudinal directions of the ellipses are different. Accordingly, the lens array 61g can make a pixel virtual image 73P configured by a pixel virtual image 73L, a pixel virtual image 73M, and a pixel virtual image 73N to appear, which are respectively made to appear by the micro-lens 62e, the micro-lens 62b, and the micro-lens 62c that are included in the lens array 61g.

(6) The virtual image displaying decorative body 151 and the virtual image displaying decorative body 251 include a virtual image region 730 in which a lens array 61h configured by micro-lenses 62e and a lens array 61i configured by micro-lenses 62f are included. In the virtual image displaying decorative body 151 and the virtual image displaying decorative body 251, it is possible to make a virtual image to appear, which includes the pixel virtual image 73E and the pixel virtual image 73F.

Further, it is possible to make virtual images that are different from each other to appear at arrangement positions of two kinds of virtual image regions 730, like the virtual image displaying decorative body 151 and the virtual image displaying decorative body 251.

(7) The virtual image displaying decorative body 351 includes a virtual image region 730 in which a lens array 61c configured by the micro-lens 62c is included and a virtual image region 730 in which a lens array 61i configured by the micro-lens 62f is included. In the virtual image displaying decorative body 351, it is possible to make a virtual image to appear, which includes the pixel virtual image 73C and the pixel virtual image 73F in which the shapes of the pixel virtual image 73 are different from each other.

Further, it is possible to make virtual images to appear, in which arrangement positions of the pixel virtual image 73C and the pixel virtual image 73F are different, depending on arrangement positions of two kinds of virtual image regions 730.

(8) A liquid repellent layer 55 is formed in one surface of the base member 53, and the micro-lenses 62 are formed on the liquid repellent layer 55. Accordingly, when the micro-lens 62 is formed by arranging the functional fluid including materials of the micro-lenses 62, it is possible to easily form a swollen lens shape by preventing the functional fluid disposed on the base member 53 from being wetting spread.

Hitherto, preferred embodiments are described with reference to the attached drawings, but the preferred embodiment is not limited to the exemplary embodiments. It is a matter of course that the exemplary embodiments may be modified variously without departing from the scope and spirit, and may also be carried out as following modification examples.

### Modification Example 1

In the exemplary embodiment, the shape of the pixel unit 72 is a circle. However, the shape of the pixel unit is not limited to the circle. The shape of the pixel unit may have other shapes. Further, it is not necessary for the pixel unit to have an independent image. The pixel unit may be configured by a plurality of images.

### Modification Example 2

In the exemplary embodiments, the virtual image displaying decorative body 151 or the virtual image displaying decorative body 251 includes the lens array 61h or the lens array 61i having the micro-lens 62e or the micro-lens 62f of which the longitudinal directions are different from each other. The virtual image displaying decorative body may have a configuration which further includes a lens array 61 (light condensing element array) including other micro-lens 62 (light condensing element) of which plan view shapes are the same and the longitudinal directions are different.

### Modification Example 3

In the exemplary embodiments, the lens array 61e and the lens array 61f include the micro-lens 62e and the micro-lens 62f of which the longitudinal directions are different from each other. The lens array 61 (light condensing element array) may have a configuration which further includes other micro-lenses 62 (light condensing element) of which plan view shapes are the same and the longitudinal directions are different.

### Modification Example 4

In the exemplary embodiments, the virtual image displaying decorative body 51 includes the lens array 61a (lens array 61b), and the lens array 61c having the micro-lens 62a (micro-lens 62b) or the micro-lens 62c of which the plan view shapes are different from each other. The virtual image displaying decorative body 351 includes the lens array 61c and the lens array 61i having the micro-lens 62c or the micro-lens 62f of which the plan view shapes are different from each other. However, the virtual image displaying decorative body may have a configuration which further includes a lens array 61 (light condensing element array) including other micro-lenses 62 (light condensing element) of which plan view shapes are different from each other.

### Modification Example 5

In the exemplary embodiments, the lens array 61g includes the micro-lens 62e (micro-lens 62f), and the micro-lens 62c of which plan view shapes are different from each other. However, the lens array 61 (light condensing element array) may have a configuration which further includes other micro-lenses 62 (light condensing element) of which plan view shapes are different from each other.

### Modification Example 6

In the exemplary embodiments, the number of lens array 61 included in the virtual image displaying decorative body 51, the virtual image displaying decorative body 151, the virtual image displaying decorative body 251, and the virtual image displaying decorative body 351 is four. However, the number of lens arrays 61 (light condensing element array) included in the virtual image displaying decorative body is not limited to four. The number of lens arrays 61 (light condensing element array) included in the virtual image displaying decorative body may be any number.

### Modification Example 7

In the exemplary embodiments, the shape of the pixel virtual image 73 corresponds to that of the micro-lens 62 and is exemplified, but the shape of the virtual image made to appear actually may have various shapes. Even if the plan view shapes are the same, the shapes of the virtual images made to appear may be different depending on the thickness of the micro-lens 62 (light condensing element). Further, the shape of the cross section of the micro-lens 62 (light condensing element) may vary even depending on a contacting angle with respect to a base surface of the functional fluid to be used for forming the micro-lens 62 (light condensing element), so that the shapes of the virtual image made to appear become different.

### Modification Example 8

In the exemplary embodiments, the relationship between the arrangement pitch P2 of the micro-lens 62 in the lens array 61 in the virtual image displaying decorative body 51 and the arrangement pitch P1 of the pixel unit 72 in the pixel array 71 is established that pitch P1<pitch P2. Further, it satisfies a relationship in which pitch P2×(the number of columns or the number of rows of the micro-lenses 62 in the lens array 61-1)=pitch P1×(the number of columns or the number of rows of the pixel unit 72 in the pixel array 71). However, the relationship between the arrangement pitch P2 of the micro-lens 62 (light condensing element) in the lens array 61 (light condensing element array) and the arrangement pitch P1 of the pixel unit in the pixel array 71 (unit array) may be established that pitch P1>pitch P2. In a case where pitch P1>pitch P2, the pitch P1, the pitch P2, the number of columns or the number of rows of the micro-lenses 62 (light condensing element) in the lens array 61 (light condensing element array), and the number of columns or the number of rows of the pixel unit in the pixel array 71 (unit array) are set such that it satisfies a relationship in which pitch P2×(the number of columns or the number of rows of the micro-lenses 62 (light condensing element) in the lens array 61 (light condensing element array))=pitch P1×(the number of columns or the number of rows of the pixel unit in the pixel array 71 (unit array)−1).

In a case where the pitch P1<pitch P2, the virtual image made to appear is viewed deeper (in the back side) than the position of the pixel array 71 (unit array). In a case where pitch P1>pitch P2, the virtual image made to appear is viewed higher (in the front side) than the position of pixel array 71 (unit array).

### Modification Example 9

In the exemplary embodiments, the micro-lenses 62 constituting the lens array 61 included in the virtual image displaying decorative body 51, or the like is formed by using an ink jet type droplet ejecting apparatus 1, whereby the lens array 61 is formed. However, it is not essential to arrange a material of the micro-lens 62 (light condensing element) by using the droplet ejecting apparatus. The micro-lens 62 (light condensing element) may be formed by using other printing methods.

### Modification Example 10

In the exemplary embodiments, the micro-lens 62c has approximately circular shape in a plan view. Without being limited thereto, the plan view shape may have an elliptical shape or a polygonal shape which is different from the micro-lens 62a or the micro-lens 62b.

The entire disclosure of Japanese Patent Application No. 2012-170876, filed Aug. 1, 2012 is expressly incorporated by reference herein.

What is claimed is:

1. A virtual image displaying decorative body comprising:
a unit array including pixel units arranged; and
a light condensing element array including a plurality of light condensing elements, the light condensing elements being arranged at positions associated with the pixel units,
wherein the light condensing element array includes the light condensing elements of which plan view shapes are ellipses.

2. The virtual image displaying decorative body according to claim 1, further comprising:
first light condensing elements of which each longitudinal direction of the ellipse is a first direction; and
second light condensing elements of which each longitudinal direction of the ellipse is a second direction different from the first direction.

3. The virtual image displaying decorative body according to claim 1, further comprising:
third light condensing elements of which each plan view shape is a first ellipse; and
fourth light condensing elements of which each plan view shape is different from the first ellipse.

4. The virtual image displaying decorative body according to claim 2, further comprising:
a first light condensing element array including the first light condensing elements and the second light condensing elements.

5. The virtual image displaying decorative body according to claim 3, further comprising:
a second light condensing element array including the third light condensing elements and the fourth light condensing elements.

6. The virtual image displaying decorative body according to claim 2, further comprising:
a third light condensing element array including the first light condensing elements; and
a fourth light condensing element array including the second light condensing elements.

7. The virtual image displaying decorative body according to claim 3, further comprising:
a fifth light condensing element array including the third light condensing elements; and
a sixth light condensing element array including the fourth light condensing elements.

8. A method of manufacturing a virtual image displaying decorative body which includes a unit array including pixel units arranged, and a light condensing element array including a plurality of light condensing elements, the light condensing elements being arranged at positions associated with the pixel units,
wherein the light condensing element array includes the light condensing elements of which plan view shapes are ellipses, and
wherein both or one of the pixel unit and the light condensing element are formed using a droplet ejecting apparatus that ejects droplets.
